(19) United States
(12) Patent Application Publication
(10) Pub. No.: US 2015/0024198 A1
(43) Pub. Date: Jan. 22, 2015

(54) PRESSURE-SENSITIVE ADHESIVE COMPOSITION, PRESSURE-SENSITIVE ADHESIVE LAYER, PRESSURE-SENSITIVE ADHESIVE SHEET, SURFACE PROTECTIVE SHEET, OPTICAL SURFACE PROTECTIVE SHEET, AND OPTICAL FILM WITH SURFACE PROTECTIVE SHEET

(71) Applicant: NITTO DENKO CORPORATION, Osaka (JP)

(72) Inventors: Masato YAMAGATA, Osaka (JP); Masayuki OKAMOTO, Osaka (JP); Kiyoe SHIGETOMI, Osaka (JP); Ryo KANNO, Osaka (JP)

(73) Assignee: NITTO DENKO CORPORATION, Osaka (JP)

(21) Appl. No.: 14/506,225

(22) Filed: Oct. 3, 2014

Related U.S. Application Data
(63) Continuation of application No. PCT/JP2013/002248, filed on Apr. 1, 2013.

(30) Foreign Application Priority Data
Apr. 6, 2012 (JP) 2012-087982

(51) Int. Cl. C09J 133/14; C09J 7/02

(52) U.S. Cl. CPC C09J 133/14; C09J 7/0217; C09J 7/0246; C09J 7/0264
USPC 428/355 AC; 524/265; 525/101; 428/447

(57) ABSTRACT

A pressure-sensitive adhesive composition includes: 100 parts by mass of a polymer (A) (Tg:lower than 0° C.); 0.05 to 3 parts by mass of a (meth)acrylic polymer (B) (M_{WB}:1000≦M_{WB}<50000, Tg:30 to 300° C.); and an organopolysiloxane compound (C) having a polyoxyalkylene chain, represented by any one of the following general formulae (C1) to (C3).

[In (C1) to (C3), R₁ is a monovalent organic group, each of R₂ to R₄ is an alkylene group, R₅ is a hydrogen or an organic group, and each of a and b is an integer of 0 to 1000 (however, they are not 0 at a time); In (C1), each of m and n is an integer of 0 to 1000 (however, they are not 0 at a time); and In (C2) and (C3), m is an integer of 1 to 2000.]

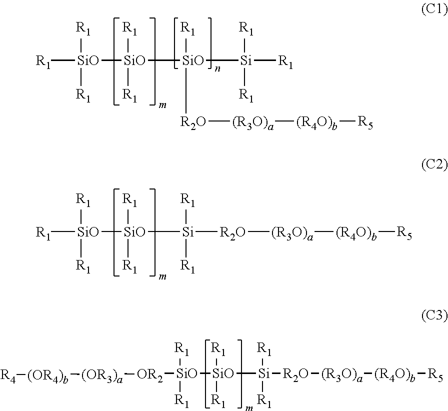

### BACKGROUND OF THE INVENTION

1. Field of the Invention

The present invention relates to a peelable pressure-sensitive adhesive composition, and a peelable pressure-sensitive adhesive layer and a peelable pressure-sensitive adhesive sheet that have the composition. The peelable pressure-sensitive adhesive sheet of the invention can be used as a surface protective sheet that protects the surface of an adherend, for example, when attached to the adherend and that is able to be easily peeled after being used. In particular, the sheet can be used as an optical surface protective sheet to be used for protecting the surface of an optical member such as a polarizing plate, wavelength plate, optical compensation film, reflective sheet, or the like, and can also be used as an optical film with surface protective sheet in which an optical surface protective sheet is attached to the optical member.

2. Description of the Related Art

A peelable pressure-sensitive adhesive sheet, which is peeled after being attached to an adherend for a certain period of time, is known. For example, a surface protective sheet is used for preventing a scratch or stain, which may be generated during the process or conveyance of an object to be protected, by being attached to the object to be protected via a pressure-sensitive adhesive generally applied to the side of the surface protective sheet. The surface protective sheet is peeled and removed (repeeled) when becoming unnecessary. Stainless steel products, plastic products, and glass plates, etc., are known as objects to be protected, but recently surface protective sheets (optical surface protective sheets) are attached in order to prevent scratches or stains in optical members (optical films) to be attached to liquid crystal cells in liquid crystal displays.

As described above, the surface protective sheets are peeled and removed when becoming unnecessary, and in this case they are mostly peeled at relatively high speed from the viewpoint of work efficiency. Accordingly, if the pressure-sensitive adhesive force at high-speed peeling is high, there have been the problems that: work efficiency becomes decreased; and an object to be protected, such as an optical member, glass, or the like, may be damaged when the sheet is peeled. On the other hand, if the pressure-sensitive adhesive force at high-speed peeling is intended to be made sufficiently small, there have been the problems that: the pressure-sensitive adhesive force at low-speed peeling is also decreased; and a defect such as pop-off or peeing may be caused after a punching process of an object to be protected or a polishing treatment of the end surface thereof. Additionally, when the surface protective sheets are used for protecting the surfaces of optical members, adherends are sometimes inspected while the surface protective sheets are being attached thereto, and hence the surface protective sheets are required to have high transparency themselves.

To meet such a demand, as a surface protective sheet in which: high-speed peelability is good; zipping is not caused; an adherend is not polluted after the sheet is peeled; and a change in peeling force depending on peeling speed is small, a surface protective sheet, which is made by applying a pressure-sensitive adhesive for protective sheet to a supporting body, is proposed, the pressure-sensitive adhesive for protective sheet being made: by using a (meth)acrylic polymer having a glass transition temperature of a certain value or less and a (meth)acrylic polymer having that of a certain value or more in combination; and by subjecting the polymers to a crosslinking reaction such that a gel fraction becomes a certain value or more (see Patent Document 1). However, the adhesiveness at low-speed peeling may be deteriorated, and in particular the transparency is not acceptable.

### RELATED ART DOCUMENT

### Patent Document

[Patent Document 1] Japanese Patent Application Publication No. 2005-146151

### SUMMARY OF THE INVENTION

So, the present invention has been made in view of these situations and a purpose of the invention is to provide: a pressure-sensitive adhesive composition in which the pressure-sensitive adhesive force at high-speed peeling is small, the pressure-sensitive adhesive force at low-speed peeling is high to a degree in which a defect such as pop-off or peeling is not caused, and transparency is excellent; a pressure-sensitive adhesive layer using the pressure-sensitive adhesive composition; and a pressure-sensitive adhesive sheet, a surface protective sheet, an optical surface protective sheet, and an optical film with surface protective sheet.

An aspect of the present invention is a pressure-sensitive adhesive composition. The pressure-sensitive adhesive composition includes: 100 parts by mass of a polymer (A) having a glass transition temperature lower than 0° C.; 0.05 parts by mass to 3 parts by mass of a (meth)acrylic polymer (B) having a weight average molecular weight (M_{WB}) of 1000≦M_{WB}<50000 and a glass transition temperature of 30 to 300° C.; and an organopolysiloxane compound (C) having a polyoxyalkylene chain, represented by any one of the following general formulae (C1) to (C3).

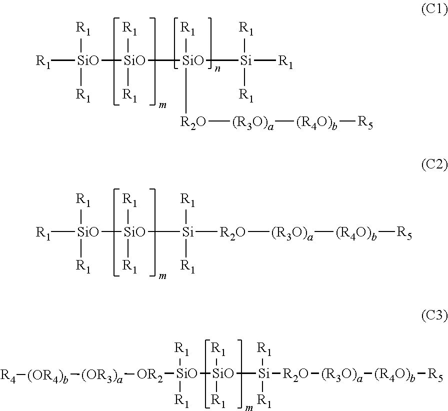

[In Formula (C1), R₁ is a monovalent organic group, each of R₂, R₃, and R₄ is an alkylene group, R₅ is a hydrogen or an organic group, each of m and n is an integer of 0 to 1000 (however, they are not 0 at a time), and each of a and b is an integer of 0 to 1000 (however, they are not 0 at a time)];

[In Formula (C2), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time)]; and

[In Formula (C3), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time).]

The pressure-sensitive adhesive composition of the aspect may include 0.01 to 2.5 parts by mass of the compound (C). Additionally, the polymer (A) may be an acrylic polymer.

In the pressure-sensitive adhesive composition of the aspect, the (meth)acrylic polymer (B) may be a (meth)acrylic polymer including, as a monomer unit, a (meth)acrylic monomer having an alicyclic structure represented by the following general formula (1):

CH₂═C(R¹)COOR² (1)

[wherein R¹ is a hydrogen atom or a methyl group and R² is an alicyclic hydrocarbon group having an alicyclic structure.]

In the pressure-sensitive adhesive composition of the aspect, the alicyclic hydrocarbon group of the (meth)acrylic monomer having an alicyclic structure may have a bridged ring structure.

In the pressure-sensitive adhesive composition of the aspect, the acrylic polymer may further include, as a monomer component, a hydroxyl group-containing (meth)acrylic monomer.

Still another aspect of the present invention is a pressure-sensitive adhesive layer. The pressure-sensitive adhesive layer is made of the pressure-sensitive adhesive composition according to any one of the aforementioned aspects.

The aforementioned pressure-sensitive adhesive layer may include 85.00 to 99.95% by mass of a solvent-insoluble component.

Still another aspect of the present invention is a pressure-sensitive adhesive sheet. The pressure-sensitive adhesive sheet is made by forming the pressure-sensitive adhesive layer of any one of the aforementioned aspects on at least one surface of a supporting body.

In the aforementioned pressure-sensitive adhesive sheet, the supporting body may be a plastic film subjected to an antistatic treatment.

Still another aspect of the present invention is a surface protective sheet. The surface protective sheet is made of the pressure-sensitive adhesive sheet of any one of the aforementioned aspects.

Still another aspect of the present invention is an optical surface protective sheet. The optical surface protective sheet is made of the surface protective sheet of the aforementioned aspect, and is used for protecting the surface of an optical film.

Still another aspect of the present invention is an optical film with surface protective sheet. In the optical film with surface protective sheet, the optical surface protective sheet of the aforementioned aspect is attached to an optical film.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is a side view explaining a low-speed peeling test (constant load peeling); and

FIG. 2 is a side view explaining a high-speed peeling test (180° peeling pressure-sensitive adhesive force).

### DETAILED DESCRIPTION OF THE INVENTION

The invention will now be described by reference to the preferred embodiments. This does not intend to limit the scope of the present invention, but to exemplify the invention.

A pressure-sensitive adhesive composition according to the present embodiment includes: 100 parts by mass of a polymer (A) having a glass transition temperature lower than 0° C., as a pressure-sensitive adhesive composite; 0.05 parts by mass to 3 parts by mass of a (meth)acrylic polymer (B) having a weight average molecular weight (M_{WB}) of 1000≦M_{WB}<50000 and a glass transition temperature of 30 to 300° C. (hereinafter, appropriately referred to as a (meth)acrylic polymer (B)); and an organopolysiloxane compound (C) having a polyoxyalkylene chain, represented by any one of the following general formulae (C1) to (C3).

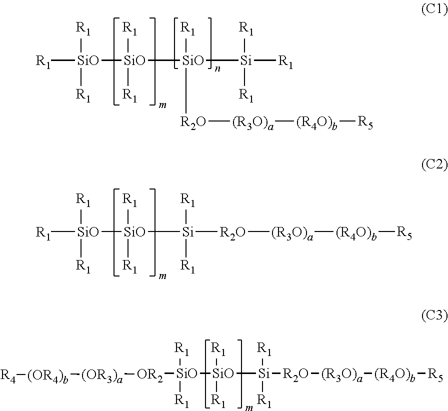

[In Formula (C1), R₁ is a monovalent organic group, each of R₂, R₃, and R₄ is an alkylene group, R₅ is a hydrogen or an organic group, each of m and n is an integer of 0 to 1000 (however, they are not 0 at a time), and each of a and b is an integer of 0 to 1000 (however, they are not 0 at a time)];

[In Formula (C2), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time)]; and

[In Formula (C3), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time).]

Hereinafter, the polymer (A) and the (meth)acrylic polymer (B) will be described in detail.

### [Polymer (A)]

The polymer (A) is not particularly limited as far as the glass transition temperature of which is lower than 0° C., and various polymers to be generally used as a pressure-sensitive adhesive, such as an acrylic polymer, rubber polymer, silicone polymer, polyurethane polymer, and polyester polymer, can be used. In particular, an acrylic polymer that is easily compatible with the (meth)acrylic polymer (B) and has high transparency is preferred.

The glass transition temperature (Tg) of the polymer (A) is lower than 0° C., preferably lower than −10° C., and more preferably lower than −40° C., and usually −80° C. or higher. If the glass transition temperature (Tg) of the polymer (A) is 0° C. or higher, it becomes difficult for the polymer to flow and the wetting to an adherend becomes insufficient, and hence the adhesiveness may be deteriorated.

The weight average molecular weight (M_{WA}) of the polymer (A) is, for example, 30,000 to 5,000,000, preferably 100,000 to 2,000,000, and more preferably 200,000 to 1,000,000. If the weight average molecular weight (M_{WA}) is less than 30,000, the cohesive force of the pressure-sensitive adhesive becomes insufficient, and hence pollution of an adherend may be easily caused. On the other hand, if the weight average molecular weight (M_{WA}) is more than 5,000,000, the flowability of the pressure-sensitive adhesive becomes low and the wetting to an adherend becomes insufficient, and hence the adhesiveness may be deteriorated.

[(Meth)Acrylic Polymer (a)]

Hereinafter, a (meth)acrylic polymer (a), which is a preferred specific example of the polymer (A), will be described in detail.

The (meth)acrylic polymer (a) is a polymer containing, as a monomer unit, a (meth)acrylic acid alkyl ester having, for example, a C₁₋₂₀ linear or branched alkyl group, in an amount of 50% by mass or more. Additionally, the (meth)acrylic polymer (a) may have a structure formed only by a (meth)acrylic acid alkyl ester having a C₁₋₂₀ alkyl group or formed by a combination of two or more thereof. A method of obtaining the (meth)acrylic polymer (a) is not particularly limited, but the polymer can be obtained by applying various polymerization methods that are generally used as a method of synthesizing an acrylic polymer, such as solution polymerization, emulsion polymerization, block polymerization, suspension polymerization, and radiation curing polymerization. When the peelable pressure-sensitive adhesive sheet of the present embodiment is used as the later-described surface protective sheet, solution polymerization and emulsion polymerization can be used preferably.

The ratio of the (meth)acrylic acid alkyl ester having a C₁₋₂₀ alkyl group to the total mass of the monomer components for preparing the (meth)acrylic polymer (a) is 50% by mass to 99.9% by mass, preferably 60% by mass to 98% by mass, and more preferably 70% by mass to 95% by mass.

Examples of the (meth)acrylic acid alkyl ester having a C₁₋₂₀ alkyl group include, for example: (meth)acrylic acid C₁₋₂₀ alkyl esters [preferably (meth)acrylic acid C₂₋₁₄ alkyl esters, and more preferably (meth)acrylic acid C₂₋₁₀ alkyl esters], such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nonadecyl, and (meth)acrylic acid eicosyl. Herein, the (meth)acrylic acid alkyl ester means an acrylic acid alkyl ester and/or a methacrylic acid alkyl ester, and all of the “(meth) . . . ” expressions have the same meaning.

For the purpose of modifying cohesive force, heat resistance, and cross-linking property, etc., the (meth)acrylic polymer (a) may contain, if necessary, another monomer component (copolymerizable monomer) that is copolymerizable with the (meth)acrylic acid alkyl ester. Accordingly, the acrylic polymer may contain a copolymerizable monomer along with the (meth)acrylic acid alkyl ester as a major component. A monomer having a polar group can be preferably used as the copolymerizable monomer.

Specific examples of the copolymerizable monomer include: carboxyl group-containing monomers, such as acrylate, methacrylic acid, carboxy ethyl acrylate, carboxypentyl acrylate, itaconic acid, maleic acid, fumaric acid, crotonic acid, and isocrotonic acid; hydroxyl group-containing monomers, such as (meth)acrylic acid hydroxyalkyls including (meth)acrylic acid 2-hydroxyethyl, (meth)acrylic acid 3-hydroxypropyl, (meth)acrylic acid 4-hydroxybutyl, (meth)acrylic acid 6-hydroxyhexyl, (meth)acrylic acid 8-hydroxyoctyl, (meth)acrylic acid 10-hydroxydecyl, (meth)acrylic acid 12-hydroxy lauryl, and (4-hydroxymethyl cyclohexyl)methyl(meth)acrylate; acid anhydride group-containing monomers, such as maleic acid anhydride and itaconic acid anhydride; sulfonic group-containing monomers, such as styrenesulfonic acid, allylsulfonic acid, 2-(meth)acrylamide-2-methylpropanesulfonic acid, (meth)acrylamide propanesulfonic acid, sulfopropyl(meth)acrylate, and (meth)acryloyloxy naphthalenesulfonic acid; phosphate group-containing monomers, such as 2-hydroxyethyl acryloyl phosphate; (N-substituted)amide monomers, such as (meth)acrylamide, N,N-dialkyl(meth)acrylamides including N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, and N,N-di(t-butyl)(meth)acrylamide, etc., N-ethyl(meth)acrylamide, N-isopropyl(meth)acrylamide, N-butyl(meth)acrylamide, N-n-butyl(meth)acrylamide, N-methylol(meth)acrylamide, N-ethylol(meth)acrylamide, N-methylolpropane(meth)acrylamide, N-methoxymethyl(meth)acrylamide,

N-methoxyethyl(meth)acrylamide, N-butoxymethyl(meth)acrylamide, and N-acryloyl morpholine; succinimide monomers, such as N-(meth)acryloyloxy methylene succinimide, N-(meth)acryloyl-6-oxy hexamethylene succinimide, and N-(meth)acryloyl-8-oxy octamethylene succinimide; maleimide monomers, such as N-cyclohexyl maleimide, N-isopropylmaleimide, N-lauryl maleimide, and N-phenyl maleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; vinyl esters, such as vinyl acetate and vinyl propionate; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloyl pyrrolidine, N-vinyl morpholine, N-vinyl-2-piperidone, N-vinyl-3-morpholinone, N-vinyl-2-caprolactam, N-vinyl-1,3-oxazine-2-one, N-vinyl-3,5-morpholinedione, N-vinyl pyrazole, N-vinyl isoxazole, N-vinyl thiazole, N-vinyl isothiazole, and N-vinyl pyridazine; N-vinyl carboxylic acid amides; lactam monomers, such as N-vinyl caprolactam; cyano group-containing monomers, such as acrylonitrile and methacrylonitrile; (meth)acrylic acid aminoalkyl monomers, such as (meth)acrylic acid aminoethyl, (meth)acrylic acid N,N-dimethylaminoethyl, and (meth)acrylic acid t-butylaminoethyl; (meth)acrylic acid alkoxy alkyl monomers, such as (meth)acrylic acid methoxyethyl, (meth)acrylic acid ethoxyethyl, (meth)acrylic acid propoxyethyl, (meth)acrylic acid butoxyethyl, and (meth)acrylic acid ethoxypropyl; styrene monomers, such as styrene and α-methylstyrene; epoxy group-containing acrylic monomers, such as (meth)acrylic acid glycidyl; glycol acrylic ester monomers, such as (meth)acrylic acid polyethylene glycol, (meth)acrylic acid polypropylene glycol, (meth)acrylic acid methoxy ethylene glycol, and (meth)acrylic acid methoxy polypropylene glycol; acrylic acid ester monomers having a heterocycle, halogen atom, silicon atom, or the like, such as (meth)acrylic acid tetrahydrofurfuryl, fluorine atom-containing (meth)acrylate, and silicone(meth)acrylate; olefin monomers, such as isoprene, butadiene, and isobutylene; vinyl ether monomers, such as methyl vinyl ether and ethyl vinyl ether; vinyl esters, such as vinyl acetate and vinyl propionate; aromatic vinyl compounds, such as vinyl toluene and styrene; olefins or dienes, such as ethylene, butadiene, isoprene, and isobutylene; vinyl ethers, such as vinyl alkyl ether; vinyl chloride; sulfonic acid group-containing monomers, such as vinyl sulfonate sodium; imide group-containing monomers, such as cyclohexyl maleimide and isopropyl maleimide; isocyanate group-containing monomers, such as 2-isocyanate ethyl(meth)acrylate; acryloyl morpholine; (meth)acrylic acid esters having an alicyclic hydrocarbon group, such as cyclopentyl(meth)acrylate, cyclohexyl(meth)acrylate, isobornyl(meth)acrylate, and dicyclopentanyl(meth)acrylate; (meth)acrylic acid esters having an aromatic hydrocarbon group, such as phenyl(meth)acrylate, and phenoxyethyl(meth)acrylate; (meth)acrylic acid esters obtained from terpene compound derivative alcohols; and the like. These copolymerizable monomers can be used alone or in combination of two or more thereof.

When the (meth)acrylic polymer (a) contains a copolymerizable monomer along with the (meth)alkyl acid alkyl ester as a major component, hydroxyl group-containing monomers and carboxyl group-containing monomers can be preferably used. Among them, (meth)acrylic acid 2-hydroxyethyl and (meth)acrylic acid 4-hydroxybutyl can be preferably used as the hydroxyl group-containing monomers, and an acrylic acid can be preferably used as the carboxyl group-containing monomer. The use amount of the copolymerizable monomer is not particularly limited, but the copolymerizable monomer can be contained in an amount usually within a range of 0.01% by mass to 40% by mass, preferably 0.1% by mass to 30% by mass, and more preferably 0.5% by mass to 20% by mass, based on the total mass of the monomer components for preparing the acrylic polymer.

By containing 0.01% by mass or more of the copolymerizable monomer, the cohesive force of the acrylic pressure-sensitive adhesive sheet, having a pressure-sensitive adhesive layer formed by the acrylic pressure-sensitive adhesive composition, can be prevented from being decreased, and pollution of an adherend, possibly occurring when the sheet is peeled from the adherend, can be prevented. Further, by containing the copolymerizable monomer in an amount of 40% by mass or less, the cohesive force can be prevented from becoming too large, and the tackiness at normal temperature (25° C.) can be improved.

The (meth)acrylic polymer (a) may also contain, if necessary, a polyfunctional monomer, in order to adjust the cohesive force of the acrylic pressure-sensitive adhesive composition to be formed.

Examples of the polyfunctional monomer include, for example, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecanediol di(meth)acrylate, trimethylolpropane tri(meth)acrylate, tetramethylol methane tri(meth)acrylate, allyl(meth)acrylate, vinyl(meth)acrylate, divinylbenzene, epoxy acrylate, polyester acrylate, urethane acrylate, butanediol di(meth)acrylate, and hexanediol di(meth)acrylate, etc. Among them, trimethylolpropane tri(meth)acrylate, hexanediol di(meth)acrylate, and dipentaerythritol hexa(meth)acrylate can be preferably used. The polyfunctional (meth)acrylates can be used alone or in combination of two or more thereof.

The use amount of the polyfunctional monomer is changed depending on the molecular weight or the number of functional groups thereof, but the polyfunctional monomer is added in an amount within a range of 0.01% by mass to 3.0% by mass, preferably within a range of 0.02% by mass to 2.0% by mass, and more preferably within a range of 0.03% by mass to 1.0% by mass, based on the total mass of the monomer components for preparing the (meth)acrylic polymer (a).

If the use amount of the polyfunctional monomer is more than 3.0% by mass, based on the total mass of the monomer components for preparing the (meth)acrylic polymer (a), for example, the cohesive force of the acrylic pressure-sensitive adhesive composition becomes too large, and hence the adhesive force (high-speed peeling force, low-speed peeling force) may be decreased. On the other hand, if the use amount is less than 0.01% by mass, for example, the cohesive force of the acrylic pressure-sensitive adhesive composition is decreased, and when peeled from an adherend (object to be protected), the composition may pollute the adherend.

In preparing the (meth)acrylic polymer (a), the acrylic polymer can be easily formed by a curing reaction using heat or ultraviolet rays with the use of a polymerization initiator, such as a thermal polymerization initiator, photo-polymerization initiator (photo-initiator), or the like. In particular, a thermal polymerization initiator can be preferably used in terms of the advantage that a polymerization time can be shortened. The polymerization initiators can be used alone or in combination of two or more thereof.

Examples of the thermal polymerization initiator include, for example: azo polymerization initiators (e.g., 2,2′-azobisisobutyronitrile, 2,2′-azobis-2-methylbutyronitrile, 2,2′-azobis(2-methylpropionic acid)dimethyl, 4,4′-azobis-4-cyanovalerianic acid, azobis isovaleronitrile, 2,2′-azobis(2-amidinopropane)dihydrochloride, 2,2′-azobis[2-(5-methyl-2-imidazoline-2-yl) propane]dihydrochloride, 2,2′-azobis(2-methylpropionamidine)disulfate, and 2,2′-azobis(N,N′-dimethyleneisobutylamidine)dihydrochloride, etc.); peroxide polymerization initiators (e.g., dibenzoyl peroxide, t-butyl permaleate, and lauroyl peroxide, etc.); redox polymerization initiators; and the like.

The use amount of the thermal polymerization initiator is not particularly limited, but the thermal polymerization initiator is combined, for example, in an amount within a range of 0.01 parts by mass to 5 parts by mass, and preferably within a range of 0.05 parts by mass to 3 parts by mass, based on 100 parts by mass of the monomer components for preparing the (meth)acrylic polymer (a).

The photo-polymerization initiator is not particularly limited, but, for example, a benzoin ether photo-polymerization initiator, acetophenone photo-polymerization initiator, α-ketol photo-polymerization initiator, aromatic sulfonyl chloride photo-polymerization initiator, photoactive oxime photo-polymerization initiator, benzoin photo-polymerization initiator, benzyl photo-polymerization initiator, benzophenone photo-polymerization initiator, ketal photo-polymerization initiator, thioxanthone photo-polymerization initiator, acylphosphine oxide photo-polymerization initiator, or the like, can be used.

Specific examples of the benzoin ether photo-polymerization initiator include, for example, benzoin methyl ether, benzoin ethyl ether, benzoin propyl ether, benzoin isopropyl ether, benzoin isobutyl ether, 2,2-dimethoxy-1,2-diphenylethane-1-one [product name: IRGACURE 651, made by BASF], and anisoin methyl ether, etc. Specific examples of the acetophenone photo-polymerization initiator include, for example: 1-hydroxycyclohexyl phenyl ketone [product name: IRGACURE 184, made by BASF], 4-phenoxy dichloroacetophenone, 4-t-butyl-dichloroacetophenone, 1-[4-(2-hydroxyethoxy)-phenyl]-2-hydroxy-2-methyl-1-propane-1-one [product name: IRGACURE 2959, made by BASF], 2-hydroxy-2-methyl-1-phenyl-propane-1-one [product name: DAROCUR 1173, made by BASF], and methoxy acetophenone, etc. Specific examples of the α-ketol photo-polymerization initiator include, for example: 2-methyl-2-hydroxy propiophenone and 1-[4-(2-hydroxyethyl)-phenyl]-2-hydroxy-2-methylpropane-1-one, etc. Specific examples of the aromatic sulfonyl chloride photo-polymerization initiator include, for example, 2-naphthalene sulfonyl chloride, etc. Specific examples of the photoactive oxime photo-polymerization initiator include, for example, 1-phenyl-1,2-propanedione-2-(O-ethoxycarbonyl)-oxime, etc.

Specific examples of the benzoin photo-polymerization initiator include, for example, benzoin, etc. Specific examples of the benzyl photo-polymerization initiator include, for example, benzyl, etc. Specific examples of the benzophenone photo-polymerization initiators include, for example, benzophenone, benzoylbenzoic acid, 3,3′-dimethyl-4-methoxybenzophenone, polyvinyl benzophenone, and α-hydroxy cyclohexyl phenyl ketone, etc. Specific examples of the ketal photo-polymerization initiator include, for example, benzyl dimethyl ketal, etc. Specific examples of the thioxanthone photo-polymerization initiato include, for example, thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, isopropyl thioxanthone, 2,4-diisopropyl thioxanthone, and dodecyl thioxanthone, etc.

Examples of the acylphosphine oxide photo-polymerization initiator include, for example: bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl)phosphine oxide, bis(2,6-dibutoxybenzoyl)(2-methylpropane-1-yl)phosphine oxide, bis(2,4-dimethoxybenzoyl)(2-methypropane-1-yl)phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethyl benzoyl)-2,4-di-n-butoxy phenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide, etc.

The use amount of the photo-polymerization initiator is not particularly limited, but the photo-polymerization initiator is combined, for example, in an amount within a range of 0.01 parts by mass to 5 parts by mass, and preferably within a range of 0.05 parts by mass to 3 parts by mass, based on 100 parts by mass of the monomer components for preparing the (meth)acrylic polymer (a).

If the use amount of the photo-polymerization initiator is less than 0.01 parts by mass, a polymerization reaction may become insufficient. If the use amount thereof is more than 5 parts by mass, an ultraviolet ray may not reach the inside of the pressure-sensitive adhesive layer, because the photo-polymerization initiator absorbs an ultraviolet ray. In this case, a decrease in the rate of polymerization is caused, or the molecular weight of the generated polymer becomes small. Thereby, the cohesive force of the pressure-sensitive adhesive layer to be formed becomes small, and when the pressure-sensitive adhesive layer is peeled from a film, part of the layer may remain on the film, so that the film may not be reused. The photo-polymerization initiators may be used alone or in combination of two or more thereof.

In the present embodiment, the (meth)acrylic polymer (a) can also be prepared as a partial polymer (acrylic polymer syrup) that can be obtained by radiating ultraviolet (UV) rays onto a mixture in which the aforementioned monomer components and the polymerization initiator have been combined, so that the monomer components are partially polymerized. An acrylic pressure-sensitive adhesive composition is prepared by combining the later-described (meth)acrylic polymer (B) into the acrylic polymer syrup, and then polymerization can also be completed by applying the pressure-sensitive adhesive composition to a predetermined object to be applied and by radiating UV rays.

The weight average molecular weight (M_{wa}) of the (meth)acrylic polymer (a) is, for example, 30,000 to 5,000,000, preferably 100,000 to 2,000,000, and more preferably 200,000 to 1,000,000. If the weight average molecular weight (M_{wa}) is smaller than the aforementioned range, the cohesive force of the pressure-sensitive adhesive becomes insufficient, and hence pollution of an adherend may be easily caused. On the other hand, if the weight average molecular weight (M_{wa}) is larger than the aforementioned range, the flowability of the pressure-sensitive adhesive becomes low and the wetting to an adherend becomes insufficient, and hence the adhesiveness may be deteriorated.

The glass transition temperature (Tg) of the (meth)acrylic polymer (a) is lower than 0° C., preferably lower than −10° C., and more preferably lower than −40° C., and usually −80° C. or higher. If the glass transition temperature (Tg) of the (meth)acrylic polymer (a) is 0° C. or higher, it becomes difficult for the polymer to flow and the wetting to an adherend becomes insufficient, and hence the adhesiveness may be deteriorated.

### [(Meth)Acrylic Polymer (B)]

The (meth)acrylic polymer (B) has a weight average molecular weight (M_{WB}) of 1000≦M_{WB}<50000. The (meth)acrylic polymer (B) is a (meth)acrylic polymer including, as a monomer unit, a (meth)acrylic monomer having an alicyclic structure represented by the following general formula (1), and functions as a tackifying resin in the peelable acrylic pressure-sensitive adhesive composition of the present embodiment:

CH₂═C(R¹)COOR² (1)

[wherein R¹ is a hydrogen atom or a methyl group and R² is an alicyclic hydrocarbon group having an alicyclic structure.]

Examples of the alicyclic hydrocarbon group R² in the general formula (1) include alicyclic hydrocarbon groups, such as a cyclohexyl group, isobornyl group, and dicyclopentanyl group, etc. Examples of the (meth)acrylic acid ester having such an alicyclic hydrocarbon group include esters with alicycle alcohols of (meth)acrylic acids, such as, for example, (meth)acrylic acid cyclohexyl having a cyclohexyl group, (meth)acrylic acid isobornyl having an isobornyl group, and (meth)acrylic acid dicyclopentanyl having a dicyclopentanyl group. Thus, by making the (meth)acrylic polymer (B) have, as a monomer unit, an acrylic monomer having a relatively bulky structure, the adhesiveness at low-speed peeling can be improved.

Additionally, it is preferable in the present embodiment that the alicyclic hydrocarbon group that forms the (meth)acrylic polymer (B) has a bridged ring structure. The bridged ring structure refers to an alicyclic structure of three or more rings. By making the (meth)acrylic polymer (B) have a bulkier structure such as a bridged ring structure, the adhesiveness of the peelable acrylic pressure-sensitive adhesive composition (peelable acrylic pressure-sensitive adhesive sheet) can be further improved. In particular, the adhesiveness at low-speed peeling can be further remarkably improved.

Examples of the R², which is an alicyclic hydrocarbon group having a bridged ring structure, include, for example: a dicyclopentanyl group represented by the following formula (3a); a dicyclopentenyl group represented by the following formula (3b); an adamantyl group represented by the following formula (3c); a tricyclopentanyl group represented by the following formula (3d); and a tricyclopentenyl group represented by the following formula (3e), etc. When UV polymerization is adopted in synthesizing the (meth)acrylic polymer (B) or in producing the pressure-sensitive adhesive composition, a (meth)acrylic monomer having a saturated structure such as the dicyclopentanyl group represented by the following formula (3a), the adamantyl group represented by the following formula (3c), the tricyclopentanyl group represented by the following formula (3d), or the like, of the (meth)acrylic monomers having an alicyclic structure of three or more rings that has abridged ring structure, can be particularly and preferably used as a monomer for forming the (meth)acrylic polymer (B), from the viewpoint of hardly causing inhibition of polymerization.

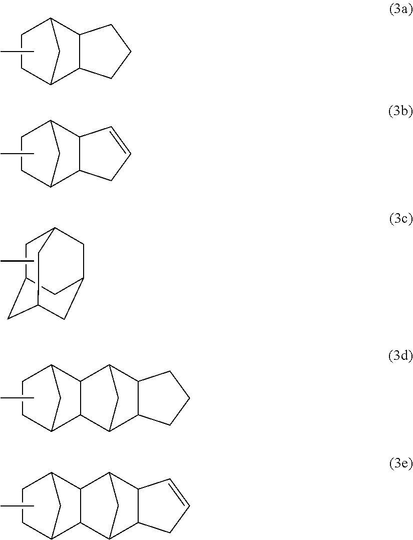

Examples of such a (meth)acrylic monomer having an alicyclic structure containing three or more rings and having a bridged ring structure include (meth)acrylic acid esters, such as dicyclopentanyl methacrylate, dicyclopentanyl acrylate, dicyclopentanyl oxyethyl methacrylate, dicyclopentanyl oxyethyl acrylate, tricyclopentanyl methacrylate, tricyclopentanyl acrylate, 1-adamantyl methacrylate, 1-adamantyl acrylate, 2-methyl-2-adamantyl methacrylate, 2-methyl-2-adamantyl acrylate, 2-ethyl-2-adamantyl methacrylate, and 2-ethyl-2-adamantyl acrylate. These (meth)acrylic monomers can be used alone or in combination of two or more thereof.

The (meth)acrylic polymer (B) of the present embodiment may be a homopolymer of a (meth)acrylic monomer having an alicyclic structure, or may be a copolymer between a (meth)acrylic monomer having an alicyclic structure and another (meth)acrylic acid ester monomer or a copolymerizable monomer.

Examples of such a (meth)acrylic acid ester monomer include: (meth)acrylic acid alkyl esters, such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid-2-ethylhexyl, (meth)acrylic acid heptyl, (meth)acrylic acid octyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, and (meth)acrylic acid dodecyl; (meth)acrylic acid aryl esters, such as (meth)acrylic acid phenyl and (meth)acrylic acid benzyl; (meth)acrylic acid esters obtained from terpene compound derivative alcohols; and the like. These (meth)acrylic acid esters can be used alone or in combination of two or more thereof.

Alternatively, the (meth)acrylic polymer (B) can also be obtained by copolymerizing another monomer component (copolymerizable monomer) that is copolymerizable with the (meth)acrylic acid ester, in addition to the aforementioned (meth)acrylic acid ester component unit.

Examples of the another monomer that is copolymerizable with the (meth)acrylic acid ester include: carboxyl group-containing monomers, such as acrylate, methacrylic acid, carboxy ethyl acrylate, carboxypentyl acrylate, itaconic acid, maleic acid, fumaric acid, crotonic acid, and isocrotonic acid; (meth)acrylic acid alkoxy alkyl monomers, such as (meth)acrylic acid methoxyethyl, (meth)acrylic acid ethoxyethyl, (meth)acrylic acid propoxyethyl, (meth)acrylic acid butoxyethyl, and (meth)acrylic acid ethoxypropyl; salts, such as (meth)acrylic acid alkali metal salt; di(meth)acrylic acid ester monomers of (poly)alkylene glycols, such as di(meth)acrylic acid ester of ethylene glycol, di(meth)acrylic acid ester of diethylene glycol, di(meth)acrylic acid ester of triethylene glycol, di(meth)acrylic acid ester of polyethylene glycol, di(meth)acrylic acid ester of propylene glycol, di(meth)acrylic acid ester of dipropylene glycol, and di(meth)acrylic acid ester of tripropylene glycol; poly(meth)acrylic acid ester monomers, such as trimethylolpropane tri(meth)acrylic acid ester; vinyl esters, such as vinyl acetate and vinyl propionate; halogenated vinyl compounds, such as vinylidene chloride and (meth)acrylic acid-2-chloroethyl; oxazoline group-containing polymerizable compounds, such as 2-vinyl-2-oxazoline, 2-vinyl-5-methyl-2-oxazoline, and 2-isopropenyl-2-oxazoline; aziridine group-containing polymerizable compounds, such as (meth)acryloylaziridine and (meth)acrylic acid-2-aziridinylethyl; epoxy group-containing vinyl monomers, such as allyl glycidyl ether, (meth)acrylic acid glycidyl, and (meth)acrylic acid ethyl glycidyl ether; hydroxyl group-containing vinyl monomers, such as (meth)acrylic acid-2-hydroxyethyl, (meth)acrylic acid-2-hydroxypropyl, and adducts between lactones and (meth)acrylic acid-2-hydroxyethyl; macromonomers in which an unsaturated group, such as a (meth)acryloyl group, styryl group, vinyl group, or the like, is bound to the end of a polyalkylene glycol, such as polypropylene glycol, polyethylene glycol, polytetramethylene glycol, polybutylene glycol, a copolymer of polyethylene glycol and polypropylene glycol, a copolymer of polybutylene glycol and polyethylene glycol, or the like; fluorine-containing vinyl monomers, such as fluorine-substituted (meth)acrylic acid alkyl ester; acid anhydride group-containing monomers, such as maleic acid anhydride and itaconic acid anhydride; aromatic vinyl compound monomers, such as styrene, α-methylstyrene, and vinyl toluene; reactive halogen-containing vinyl monomers, such as 2-chloroethyl vinyl ether and monochloro vinyl acetate; amide group-containing vinyl monomers, such as (meth)acrylamide, N-isopropyl(meth)acrylamide, N-butyl(meth)acrylamide, N,N-diethyl(meth)acrylamide, N,N-dimethyl(meth)acrylamide, N-methylol(meth)acrylamide, N-ethylol(meth)acrylamide, N-methylolpropane(meth)acrylamide, N-methoxyethyl(meth)acrylamide, N-butoxymethyl(meth)acrylamide, and N-acryloyl morpholine; succinimide monomers, such as N-(meth)acryloyloxy methylene succinimide, N-(meth)acryloyl-6-oxy hexamethylene succinimide, and N-(meth)acryloyl-8-oxy octamethylene succinimide; maleimide monomers, such as N-cyclohexyl maleimide, N-isopropylmaleimide, N-lauryl maleimide, and N-phenyl maleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinyl morpholine, N-vinyl pyrazole, N-vinyl isoxazole, N-vinyl thiazole, N-vinyl isothiazole, and N-vinyl pyridazine; N-vinyl carboxylic acid amides; lactam monomers, such as N-vinyl caprolactam; cyano group-containing monomers, such as (meth)acrylonitrile; (meth)acrylic acid aminoalkyl monomers, such as (meth)acrylic acid aminoethyl, (meth)acrylic acid N,N-dimethylaminoethyl, and (meth)acrylic acid t-butylaminoethyl; imide group-containing monomers, such as cyclohexyl maleimide and isopropyl maleimide; isocyanate group-containing monomers, such as 2-isocyanate ethyl (meth)acrylate; organic silicon-containing vinyl monomers, such as vinyltrimethoxysilane, γ-methacryloxpropyl trimethoxy silane, allyltrimethoxysilane, trimethoxysilylpropylallylamine, and 2-methoxy ethoxy trimethoxy silane; hydroxyl group-containing monomers, such as (meth)acrylic acid hydroxyalkyls including (meth)acrylic acid hydroxyethyl, (meth)acrylic acid hydroxypropyl, (meth)acrylic acid hydroxybutyl, (meth)acrylic acid hydroxyhexyl, (meth)acrylic acid hydroxyoctyl, (meth)acrylic acid hydroxydecyl, (meth)acrylic acid hydroxy lauryl, and (4-hydroxymethyl cyclohexyl)methyl(meth)acrylate; acrylic acid ester monomers having a heterocycle, halogen atom, silicon atom, or the like, such as (meth)acrylic acid tetrahydrofurfuryl, fluorine atom-containing (meth)acrylate, and silicone(meth)acrylate; olefin monomers, such as isoprene, butadiene, and isobutylene; vinyl ether monomers, such as methyl vinyl ether and ethyl vinyl ether; olefins or dienes, such as ethylene, butadiene, isoprene, and isobutylene; vinyl ethers, such as vinyl alkyl ether; vinyl chloride; and others, such as macromonomers having a radically polymerizable vinyl group at the monomer end to which a vinyl group has been polymerized, etc. These monomers can be copolymerized, alone or in combination thereof, with the (meth)acrylic acid esters.

Examples of the (meth)acrylic polymer (B) include, for example: a copolymer of cyclohexyl methacrylate (CHMA) and isobutyl methacrylate (IBMA), that of cyclohexyl methacrylate (CHMA) and isobornyl methacrylate (IBXMA), that of methyl methacrylate (MMA) and isobornyl methacrylate (IBXMA), that of cyclohexyl methacrylate (CHMA) and acryloyl morpholine (ACMO), that of cyclohexyl methacrylate (CHMA) and diethylacrylamide (DEAA), that of 1-adamantyl acrylate (ADA) and methyl methacrylate (MMA), that of dicyclopentanyl methacrylate (DCPMA) and isobornyl methacrylate (IBXMA), that of dicyclopentanyl methacrylate (DCPMA) and methyl methacrylate (MMA), that of dicyclopentanyl methacrylate (DCPMA) and N-vinyl-2-pyrrolidone (NVP), that of dicyclopentanyl methacrylate (DCPMA) and hydroxyethyl methacrylate (HEMA), that of dicyclopentanyl methacrylate (DCPMA) and acrylic acid (AA), a homopolymer of dicyclopentanyl methacrylate (DCPMA), that of cyclohexyl methacrylate (CHMA), that of isobornylmethacrylate (IBXMA), that of isobornyl acrylate (IBXA), that of dicyclopentanyl acrylate (DCPA), that of 1-adamantyl methacrylate (ADMA), that of 1-adamantyl acrylate (ADA), and that of methyl methacrylate (MMA), etc.

A functional group reactive with an epoxy group or an isocyanate group may be further introduced into the (meth)acrylic polymer (B). Examples of such a functional group include a hydroxyl group, carboxyl group, amino group, amide group, and mercapto group. A monomer having such a functional group may be used (copolymerized) in producing the (meth)acrylic polymer (B).

When the (meth)acrylic polymer (B) is a copolymer between a (meth)acrylic monomer having an alicyclic structure and another (meth)acrylic acid ester monomer or a copolymerizable monomer, the content ratio of the (meth)acrylic monomer having an alicyclic structure is 5% by mass or more, preferably 10% by mass or more, more preferably 20% by mass or more, and still more preferably 30% by mass or more (usually less than 100% by mass, and preferably 90% by mass or less), in the whole monomers that form the (meth)acrylic polymer (B). When the (meth)acrylic monomer having an alicyclic structure is contained in an amount of 5% by mass or more, the adhesiveness at low-speed peeling can be improved without deteriorating the transparency. If it is contained in an amount less than 5% by mass, the adhesiveness, in particular, the adhesiveness at low-speed peeling may be deteriorated.

The weight average molecular weight (M_{WB}) of the (meth)acrylic polymer (B) is 1000≦M_{WB}<50000, preferably 1500≦M_{WB}<20000, and more preferably 2000≦M_{WB}<10000. If the weight average molecular weight is 50000 or more, the adhesiveness at low-speed peeling may be deteriorated. On the other hand, the weight average molecular weight less than 1000 is too small, and hence the pressure-sensitive adhesive force (high-speed peeling force, low-speed peeling force) of the pressure-sensitive adhesive sheet is decreased.

The weight average molecular weights of the polymer (A) and the (meth)acrylic polymer (B) can be measured by polystyrene conversion using gel permeation chromatography (GPC). Specifically, the measurement is performed in accordance with the method and conditions described in the later-described Examples.

The glass transition temperature (Tg) of the (meth)acrylic polymer (B) is 30° C. to 300° C., preferably 50° C. to 280° C., more preferably 90° C. to 280° C., and still more preferably 110° C. to 250° C. If the glass transition temperature (Tg) is lower than 30° C., satisfaction of both the high-speed peeling force and the low-speed peeling force, in which the pressure-sensitive adhesive force at high-speed peeling is small and the adhesive force at low-speed peeling is sufficiently high to a degree in which a defect such as pop-off or peeling is not caused, may not be achieved. The glass transition temperatures of typical materials that can be used as the (meth)acrylic polymer (B) in the present embodiment are shown in Table 1. The glass transition temperatures shown there are nominal values described in documents or catalogs, etc., or values calculated based on the following Equation (1) (Fox Equation).

1/Tg=W₁/Tg₁+W₂/Tg₂+ . . . +Wₙ/Tgₙ (1)

[wherein Tg represents the glass transition temperature (unit: K) of the (meth)acrylic polymer (B), Tgᵢ (i=1, 2, . . . , n) represents the glass transition temperature (unit: K) when monomer i forms a homopolymer, and Wᵢ (i=1, 2, . . . , n) represents a mass fraction of the monomer i in the whole monomer components.] The above Equation (1) is adopted when the (meth)acrylic polymer (B) is formed of n types of monomer components of monomer 1, monomer 2, . . . , monomer n.

TABLE 1

| COMPOSITION OF | | |
|---|---|---|
| (METH) ACRYLIC | | |
| POLYMER (B) | Tg (° C.) | REMARKS |
| DCPMA | 175 | VALUES DESCRIBED |
| | | IN DOCUMENTS, ETC. |
| DCPA | 120 | VALUES DESCRIBED |
| | | IN DOCUMENTS, ETC. |
| IBXMA | 173 | VALUES DESCRIBED |
| | | IN DOCUMENTS, ETC. |
| IBXA | 97 | VALUES DESCRIBED |
| | | IN DOCUMENTS, ETC. |
| CHMA | 66 | VALUES DESCRIBED |
| | | IN DOCUMENTS, ETC. |
| CHA | 15 | VALUES DESCRIBED |
| | | IN DOCUMENTS, ETC. |
| IBMA | 48 | VALUES DESCRIBED |
| | | IN DOCUMENTS, ETC. |
| MMA | 105 | VALUES DESCRIBED |
| | | IN DOCUMENTS, ETC. |
| ADMA | 250 | VALUES DESCRIBED |
| | | IN DOCUMENTS, ETC. |
| ADA | 153 | VALUES DESCRIBED |
| | | IN DOCUMENTS, ETC. |
| NVP | 54 | VALUES DESCRIBED |
| | | IN DOCUMENTS, ETC. |
| HEMA | 40 | VALUES DESCRIBED |
| | | IN DOCUMENTS, ETC. |
| DCPMA/MMA = 40/60 | 130 | CALCULATED VALUES |
| | | (BASED ON Fox EQUATION) |
| IBXA/MMA = 40/60 | 130 | CALCULATED VALUES |
| | | (BASED ON Fox EQUATION) |
| CHMA/IBMA = 60/40 | 59 | CALCULATED VALUES |
| | | (BASED ON Fox EQUATION) |
| DCPMA/NVP = 60/40 | 117 | CALCULATED VALUES |
| | | (BASED ON Fox EQUATION) |

The abbreviations in Table 1 represent the following compounds.

DCPMA: Dicyclopentanyl Methacrylate

DCPA: Dicyclopentanyl Acrylate

IBXMA: Isobornyl Methacrylate

IBXA: Isobornyl Acrylate

CHMA: Cyclohexyl Methacrylate

CHA: Cyclohexyl Acrylate

IBMA: Isobutyl Methacrylate

MMA: Methyl Methacrylate

ADMA: 1-Adamantyl Methacrylate

ADA: 1-Adamantyl Acrylate

NVP: N-Vinyl-2-Pyrrolidone

The (meth)acrylic polymer (B) can be produced, for example, by polymerizing the (meth)acrylic monomer having the aforementioned structure with the use of a solution polymerization method, bulk polymerization method, emulsion polymerization method, suspension polymerization method, block polymerization method, or the like.

In order to adjust the molecular weight of the (meth)acrylic polymer (B), a chain transfer agent can be used while the polymer (B) is being polymerized. Examples of the chain transfer agent to be used include: compounds having a mercapt group, such as octylmercaptan, laurylmercaptan, t-dodecyl mercaptan, mercaptoethanol, and α-thioglycerol; thioglycolic acid, methyl thioglycolate, ethyl thioglycolate, propyl thioglycolate, butyl thioglycolate, t-butyl thioglycolate, 2-ethylhexyl thioglycolate, octyl thioglycolate, decyl thioglycolate, dodecyl thioglycolate, and thioglycolic acid esters including thioglycolic acid ester of ethylene glycol, thioglycolic acid ester of neopentyl glycol, and thioglycolic acid ester of pentaerythritol; α-methylstyrene dimer; and the like.

The use amount of the chain transfer agent is not particularly limited, but the chain transfer agent is usually contained in an amount within a range of 0.1 parts by mass to 20 parts by mass, preferably within a range of 0.2 parts by mass to 15 parts by mass, and more preferably within a range of 0.3 parts by mass to 10 parts by mass, based on 100 parts by mass of the (meth)acrylic monomer. By adjusting the addition amount of the chain transfer agent, as stated above, the (meth)acrylic polymer (B) having a preferred molecular weight can be obtained. The chain transfer agents can be used alone or in combination of two or more thereof.

### [Organopolysiloxane Compound (C) Having Polyoxyalkylene Chain]

The organopolysiloxane compound (C) having a polyoxyalkylene chain is represented by any one of the following general formulae (C1) to (C3).

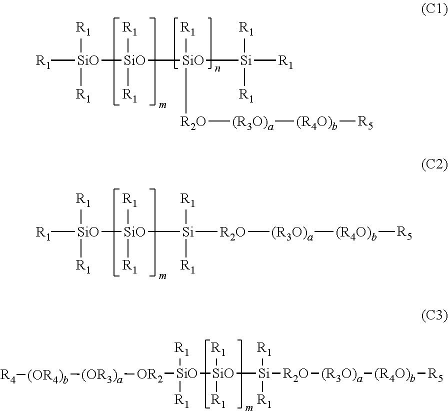

[In Formula (C1), R₁ is a monovalent organic group, each of R₂, R₃, and R₄ is an alkylene group, R₅ is a hydrogen or an organic group, each of m and n is an integer of 0 to 1000 (however, they are not 0 at a time), and each of a and b is an integer of 0 to 1000 (however, they are not 0 at a time)];

[In Formula (C2), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time)]; and

[In Formula (C3), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time).]

As the organopolysiloxane having a polyoxyalkylene chain in the present embodiment, compounds having the following structures can be used. Specifically, R₁ in the formulae is a monovalent organic group exemplified by: alkyl groups, such as a methyl group, ethyl group, and propyl group; aryl groups, such as a phenyl group and tolyl group; or aralkyl groups, such as a benzyl group and phenethyl group, each of which may have a substituent group such as a hydroxyl group. As R₂, R₃, and R₄, C₁₋₈ alkylene groups, such as a methylene group, ethylene group, and propylene group, can be used. Herein, R₃ and R₄ are alkylene groups different from each other, and R₂ may or may not be the same as R₃ or R₄. R₅ may be a monovalent organic group exemplified by: alkyl groups, such as a methyl group, ethyl group, and propyl group; or acyl groups, such as an acetyl group and propionyl group, each of which may have a substituent groups, such as a hydroxyl group. These compounds may be used alone or in combination of two or more thereof. These compounds may have, in their molecules, a reactive substituent, such as a (meth)acryloyl group, allyl group, and hydroxyl group. The organopolysiloxane having a polyoxyalkylene chain acts on the interface between an adherend and the pressure-sensitive adhesive so as to exhibit an effect of suppressing the pressure-sensitive adhesive force at high-speed peeling.

Examples of the organopolysiloxane having a polyoxyalkylene chain include, for example, commercially available products with the names of: KF-351A, KF-353, KF-945, KF-6011, KF-889, and KF-6004 (all of which are made by Shin-Etsu Chemical Co., Ltd.); FZ-2122, FZ-2164, FZ-7001, SH8400, SH8700, SF8410, and SF8422 (all of which are made by Dow Corning Toray Co., Ltd.); TSF-4440, TSF-4445, TSF-4452, and TSF-4460 (all of which are made by Momentive Performance Materials Inc.); and BYK-333, BYK-377, BYK-UV3500, and BYK-UV3570 (all of which are made by BYK Japan KK); and the like. These compounds may be used alone or in combination of two or more thereof.

### [Pressure-Sensitive Adhesive Composition]

The pressure-sensitive adhesive composition of the present embodiment includes, as essential components, the aforementioned polymer (A), (meth)acrylic polymer (B), and organopolysiloxane compound (C) having a polyoxyalkylene chain. The content of the (meth)acrylic polymer (B) is 0.05 parts by mass to 3 parts by mass, based on 100 parts by mass of the polymer (A), preferably 0.08 parts by mass to 2.5 parts by mass, and more preferably 0.1 parts by mass to 2 parts by mass. If the (meth)acrylic polymer (B) is added in an amount more than 3 parts by mass, the transparency of the pressure-sensitive adhesive layer formed by the acrylic pressure-sensitive adhesive composition according to the embodiment is deteriorated. On the other hand, if the (meth)acrylic polymer (B) is added in an amount less than 0.05 parts by mass, satisfaction of both the high-speed peeling force and the low-speed peeling force, in which the pressure-sensitive adhesive force at high-speed peeling is small and the adhesive force at low-speed peeling is sufficiently high to a degree in which a defect such as pop-off or peeling is not caused, cannot be achieved. The content of the organopolysiloxane compound (C) having a polyoxyalkylene chain is not particularly limited, but the content is preferably 0.01 parts by mass to 2.5 parts by mass, based on 100 parts by mass of the polymer (A), more preferably 0.05 parts by mass to 2 parts by mass, and still more preferably 0.1 parts by mass to 1.5 parts by mass. The aforementioned range is preferred because both the pressure-sensitive adhesive force at low-speed peeling and that at high-speed peeling can be preferably achieved.

The pressure-sensitive adhesive composition of the present embodiment can include, as optional components, various additives common in the field of pressure-sensitive adhesive compositions, in addition to the aforementioned polymer (A), (meth)acrylic polymer (B), and organopolysiloxane compound (C) having a polyoxyalkylene chain. Such optional components are exemplified by a tackifying resin, cross-linking agent, catalyst, plasticizer, softener, filler, colorant (pigment, dye, or the like), antioxidant, leveling agent, stabilizer, antiseptic, and antistatic agent, etc. Such additives that are conventionally and publicly known can be used by ordinary methods.

In order to adjust the cohesive force of the later-described pressure-sensitive adhesive layer, a cross-linking agent can also be used, other than the aforementioned polyfunctional monomers. Commonly-used cross-linking agents can be used as the cross-linking agent. Examples of the cross-linking agents include, for example: an epoxy cross-linking agent, isocyanate cross-linking agent, silicone cross-linking agent, oxazoline cross-linking agent, aziridine cross-linking agent, silane cross-linking gent, alkyl-etherified melamine cross-linking agent, and metal chelate cross-linking agent, etc. In particular, an isocyanate cross-linking agent, epoxy cross-linking agent, and metal chelate cross-linking agent can be preferably used. These compounds may be used alone or in combination of two or more thereof.

Specific examples of the isocyanate cross-linking agent include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl xylylene diisocyanate, naphthalene diisocyanate, triphenylmethane triisocyanate, polymethylene polyphenyl isocyanate, and these adducts with polyols, such as trimethylolpropane. Alternatively, a compound having, in one molecule, at least one isocyanate group and one or more unsaturated bonds, specifically 2-isocyanate ethyl(meth)acrylate, etc., can also be used as the isocyanate cross-linking agent. These compounds may be used alone or in combination of two or more thereof.

Examples of the epoxy cross-linking agent include: bisphenol A, epichlorohydrin type epoxy resin, ethylene glycol diglycidyl ether, polyethylene glycol diglycidyl ether, glycerin diglycidyl ether, glycerin triglycidyl ether, 1,6-hexanediol diglycidyl ether, trimethylolpropane triglycidyl ether, diglycidyl aniline, diamine glycidyl amine, N,N,N′,N′-tetraglycidyl-m-xylylenediamine, and 1,3-bis(N,N′-diamine glycidyl aminomethyl)cyclohexane, etc. These compounds may be used alone or in combination of two or more thereof.

Examples of the metal chelate compound include: as metal components, aluminum, iron, tin, titanium, and nickel; and as chelate components, acetylene, methyl acetoacetate, and ethyl lactate, etc. These compounds may be used alone or in combination of two or more thereof.

The cross-linking agent to be used in the present embodiment is preferably contained in an amount of 0.01 parts by mass to 15 parts by mass, and more preferably contained in an amount of 0.5 parts by mass to 10 parts by mass, based on 100 parts by mass of the polymer (A). If the content of the cross-linking agent is less than 0.01 parts by mass, the cohesive force of the pressure-sensitive adhesive becomes small, and hence pollution of an adherend may be caused. On the other hand, if the content thereof is more than 15 parts by mass, the cohesive force of the polymer becomes large, the flowability is deteriorated, and the wettability becomes insufficient, and hence the adhesiveness may be deteriorated.

The pressure-sensitive adhesive composition disclosed herein may further include a cross-linking catalyst for further effectively promoting any one of the aforementioned cross-linking reactions. As such a cross-linking catalyst, for example, a tin catalyst (in particular, dioctyl tin dilaurate) can be preferably used. The use amount of the cross-linking catalyst (e.g., a tin catalyst such as dioctyl tin dilaurate) is not particularly limited, but the use amount may be, for example, approximately 0.0001 parts by mass to 1 part by mass, based on 100 parts by mass of the polymer (A).

The pressure-sensitive adhesive composition disclosed herein may include an antistatic agent for providing an antistatic performance. As such an antistatic agent, for example, an ionic compound can be preferably used. The ionic compound is one exhibiting an ionic dissociation property at normal temperature, and can be exemplified by alkali metal salts and ionic liquids, etc. Because the ionic compound exhibits excellent conductivity, a pressure-sensitive adhesive containing a small amount of it can be provided with a sufficient antistatic performance, and hence the ionic compound is useful. The use amount of the ionic compound is not particularly limited, but may be within a range of, for example, approximately 0.005 parts by mass to 1 part by mass, based on 100 parts by mass of the polymer (A). These compounds may be used alone or in combination of two or more thereof.

The pressure-sensitive adhesive composition disclosed herein may include a compound that exhibits keto-enol tautomerism. An aspect can be preferably adopted, in which, for example, a pressure-sensitive adhesive composition including a cross-linking agent, or a pressure-sensitive adhesive composition that can be used by blending a cross-linking agent, includes the compound exhibiting keto-enol tautomerism. Thereby, an advantage can be achieved, in which an excessive rise in viscosity and gelatinization of a pressure-sensitive adhesive composition in which a cross-linking agent has been blended can be suppressed and hence the pot life of the composition can be extended. When at least an isocyanate compound is used as the cross-linking agent, it is particulalrly significant to contain the compound exhibiting keto-enol tautomerism. This technique can be preferably applied, when the aforementioned pressure-sensitive adhesive composition is, for example, in the form of an organic solvent solution or a non-solvent solution.

Various types of β-dicarbonyl compounds can be used as the compound exhibiting keto-enol tautomerism. Specific examples of the β-dicarbonyl compounds include: β-diketones, such as acetylacetone, 2,4-hexanedione, 3,5-heptanedione, 2-methylhexane-3,5-dione, 6-methylheptane-2,4-dione, and 2,6-dimethylheptane-3,5-dione; acetoacetic esters, such as methyl acetoacetate, ethyl acetoacetate, isopropyl acetoacetate, and tert-butyl acetoacetate; propionylacetic esters, such as methyl propionylacetate, ethyl propionylacetate, isopropyl propionylacetate, tert-butyl propionylacetate; isobutyrylacetic esters, such as methyl isobutyrylacetate, ethyl isobutyrylacetate, isopropyl isobutyrylacetate, and tert-butyl isobutyrylacetate; malonic esters, such as methyl malonate and ethyl malonate; and the like. Among them, acetylacetone and acetoacetic esters are used as preferred compounds. The compounds exhibiting keto-enol tautomerism may be used alone or in combination of two or more thereof.

It is proper that the use amount of the compound exhibiting keto-enol tautomerism is, for example, 0.1 parts by mass to 20 parts by mass, and usually 0.5 parts by mass to 15 parts by mass (e.g., 1 part by mass to 10 parts by mass), based on 100 parts by mass of the polymer (A). If the use amount of the compound is too small, a sufficient use effect may not be exhibited. On the other hand, if the use amount thereof is larger than necessary, the compound may remain on the pressure-sensitive adhesive layer, so that the cohesive force of the pressure-sensitive adhesive may be decreased.

### [Pressure-Sensitive Adhesive Layer and Pressure-Sensitive Adhesive Sheet]

Subsequently, the structure of a pressure-sensitive adhesive sheet, having a pressure-sensitive adhesive layer containing a pressure-sensitive adhesive composition having the aforementioned composition, will be described.

The pressure-sensitive adhesive layer of the present embodiment can be a layer in which a pressure-sensitive adhesive composition has been cured. That is, the pressure-sensitive adhesive layer can be formed by providing the pressure-sensitive adhesive composition to an appropriate supporting body (e.g., application, coating) and then by appropriately subjecting to a curing treatment. When the supporting body is a plastic substrate subjected to an antistatic treatment, the pressure-sensitive adhesive layer can be formed on an antistatic layer, or can be formed on the surface not subjected to an antistatic treatment. When two or more types of curing treatments (drying, cross-link formation, polymerization, etc.) are performed, these treatments can be performed simultaneously or in multiple stages. In the case of the pressure-sensitive adhesive composition in which a partial polymer (acrylic polymer syrup) has been used, a final copolymerization reaction is typically performed as the curing treatment (the partial polymer is subjected to a further copolymerization reaction to form a complete polymer). For example, in the case of a photo-curing pressure-sensitive adhesive composition, light radiation is performed. A curing treatment, such as cross-link formation, drying, or the like, may be performed, if necessary. For example, when a photo-curing pressure-sensitive adhesive composition needs to be dried, photo-curing may be performed after the drying of the composition. In the case of the pressure-sensitive adhesive composition in which a complete polymer has been used, a treatment, such as drying (drying by heating), cross-link formation, or the like, is typically performed as the curing treatment, if necessary.

The application/coating of the pressure-sensitive adhesive composition can be performed by using a commonly-used coater, such as, for example, a gravure roll coater, reverse roll coater, kiss roll coater, dip roll coater, bar coater, knife coater, spray coater, or the like. Alternatively, the pressure-sensitive adhesive layer may be formed by directly providing the pressure-sensitive adhesive composition to a supporting body, or the pressure-sensitive adhesive layer formed on a release liner may be transferred to a substrate.

In the present embodiment, it is desirable that the ratio of the solvent-insoluble component in the pressure-sensitive adhesive layer is within a range of 85.00% by mass to 99.95% by mass, and preferably within a range of 90.00% by mass to 99.95% by mass. If the ratio of the solvent-insoluble component is less than 85.00% by mass, the cohesive force becomes insufficient, and hence an adherend (object to be protected) may be polluted when the pressure-sensitive adhesive is peeled. On the other hand, if the ratio thereof is more than 99.95% by mass, the cohesive force becomes too large, and hence pressure-sensitive adhesive force (high-speed peeling force, low-speed peeling force) may not be obtained. A method of evaluating the ratio of the solvent-insoluble component will be described later.

The thickness of the pressure-sensitive adhesive layer is not particularly limited, but is usually within a range of, for example, 3 μm to 60 μm, and preferably within a range of 5 μm to 40 μm. By setting the thickness to be within the range, good adhesiveness can be achieved. If the thickness of the pressure-sensitive adhesive layer is less than 3 μm, the adhesiveness becomes insufficient, and hence pop-off or peeling may be caused. On the other hand, if the thickness thereof is more than 60 μm, the high-speed peeling force is increased, and hence peeling workability may be decreased.

The pressure-sensitive adhesive sheet according to the present embodiment comprises a pressure-sensitive adhesive layer made of the pressure-sensitive adhesive composition. In the pressure-sensitive adhesive sheet, such a pressure-sensitive adhesive layer is provided on at least one surface of a supporting body in a fixed manner, i.e., without an intention of separating the pressure-sensitive adhesive layer from the supporting body. The concept of the pressure-sensitive adhesive sheet described herein can involve objects referred to as a pressure-sensitive adhesive tape, a pressure-sensitive adhesive film, and a pressure-sensitive adhesive label, etc. The pressure-sensitive adhesive sheet may be one that is cut or subjected to punching processing so as to have an appropriate shape in accordance with its purpose of use. The pressure-sensitive adhesive layer is not limited to one continuously formed, but may be one formed into a regular pattern, such as, for example, a dot shape and a stripe shape, or formed into a random pattern.

The aforementioned supporting body can be formed of a material appropriately selected, in accordance with the application of the pressure-sensitive adhesive tape, from the group consisting of, for example: plastic films, such as polyolefin films including polyethylene, polypropylene, poly-1-butene, poly-4-methyl-1-pentene, ethylene propylene copolymer, ethylene 1-butene copolymer, ethylene vinyl acetate copolymer, ethylene ethyl acrylate copolymer, and ethylene vinyl alcohol copolymer, polyester films including polyethylene terephthalate, polyethylene naphthalate, and polybutylene terephthalate, polyacrylate film, polystyrene film, polyamide films including nylon 6, nylon 6, 6, and partially aromatic polyamide, polyvinylchloride film, polyvinylidene chloride film, and polycarbonate film; foam substrates, such as a polyurethane foam, and polyethylene foam; paper, such as craft paper, crepe paper, and Japanese paper; cloth, such as cotton cloth and staple fiber cloth; nonwoven cloth, such as polyester nonwoven cloth and vinylon nonwoven cloth; metallic foils, such as aluminum foil and copper foil; and the like. When the peelable acrylic pressure-sensitive adhesive sheet of the present embodiment is used as the later-described surface protective sheet, it is preferable to use, as the supporting body, a plastic film, such as a polyolefin film, polyester film, polyvinylchloride film, or the like. When the peelable acrylic pressure-sensitive adhesive sheet is used particularly as an optical surface protective sheet, it is preferable to use a polyolefin film, polyethylene terephthalate film, polybutylene terephthalate film, and polyethylene naphthalate film. As the aforementioned plastic films, both of a non-oriented film and an oriented (uniaxially oriented or biaxially oriented) film can be used.

The supporting body can also be subjected to, if necessary: a mold-release and antifouling treatment using a release agent, such as a silicone release agent, fluorine release agent, long-chain alkyl release agent, or fatty acid amide release agent, and a silica powder; and an easy-adhesion treatment, such as an acid treatment, alkali treatment, primer treatment, corona treatment, plasma treatment, ultraviolet treatment, or the like. The thickness of the supporting body can be appropriately selected in accordance with its purpose, but is generally within a range of approximately 5 μm to 200 μm (typically within a range of 10 μm to 100 μm).

The supporting body can also be subjected to, if necessary: a mold-release and antifouling treatment using a release agent, such as a silicone release agent, fluorine release agent, long-chain alkyl release agent, or fatty acid amide release agent, and a silica powder; an easy-adhesion treatment, such as an acid treatment, alkali treatment, primer treatment, corona treatment, plasma treatment, ultraviolet treatment, or the like; and an antistatic treatment, such as an application type, kneading type, vapor deposition type, or the like.

It is further preferable to subject the plastic film, which is to be used in the pressure-sensitive adhesive sheet of the present embodiment, to an antistatic treatment. By subjecting to an antistatic treatment, occurrence of static electricity can be prevented, which is useful in the technical fields related to optical and electronic components in which electrification is a particularly serious problem. The antistatic treatment performed on the plastic film is not particularly limited, but a method in which an antistatic layer is provided on at least one surface of a generally used film, and a method in which a kneading-type antistatic agent is kneaded into a plastic film, can be adopted. Examples of the method in which an antistatic layer is provided on at least one surface of a film include: a method in which an antistatic resin made of an antistatic agent and a resin component, a conductive polymer, or a conductive resin containing a conductive substance, is applied; and a method in which a conductive substance is vapor-deposited or plated.

Examples of the antistatic agent to be contained in an antistatic resin include: cationic antistatic agents having a cationic functional group, such as a quarternary ammonium salt, pyridinium salt, primary amino group, secondary amino group, and tertiary amino group; anionic antistatic agents having an anionic functional group, such as a sulfonate, sulfate, phosphonate, and phosphate; amphoteric ion type antistatic agents, such as alkylbetaine and its derivatives, imidazoline and its derivatives, and alanine and its derivatives; nonionic antistatic agents, such as amino alcohol and its derivatives, glycerin and its derivatives, and polyethylene glycol and its derivatives; and further ion conductive polymers obtained by polymerizing or copolymerizing a monomer having the aforementioned cationic, anionic, or amphoteric ion conductive group. These compounds may be used alone or in combination of two or more thereof.

Specific examples of the cationic antistatic agent include, for example: (meth)acrylate copolymers having a quaternary ammonium group, such as an alkyl trimethylammonium salt, acyloyl amide propyl trimethyl ammonium methosulfate, alkylbenzylmethylammonium salt, acyl choline chloride, and polydimethylaminoethyl methacrylate; styrene copolymers having a quaternary ammonium group, such as polyvinylbenzyl trimethylammonium chloride; and diallylamine copolymers having a quaternary ammonium group, such as polydiallyl dimethylammonium chloride; and the like. These compounds may be used alone or in combination of two or more thereof.

Examples of the anionic antistatic agent include, for example, an alkyl sulfonate, alkylbenzene sulfonate, alkyl sulfate, alkyl ethoxy sulfate, alkyl phosphate, and styrene copolymer containing a sulfonate group. These compounds may be used alone or in combination of two or more thereof.

Examples of the amphoteric antistatic agent include, for example, an alkylbetaine, alkyl imidazolium betaine, and carbobetaine graft copolymer. These compounds may be used alone or in combination of two or more thereof.

Examples of the nonionic antistatic agent include, for example, a fatty acid alkylol amide, di(2-hydroxyethyl)alkylamine, polyoxyethylene alkylamine, fatty acid glycerin ester, polyoxyethylene glycol fatty acid ester, sorbitan fatty acid ester, polyoxyethylene sorbitan fatty acid ester, polyoxyethylene alkylphenyl ether, polyoxyethylene alkyl ether, polyethylene glycol, polyoxyethylene diamine, copolymer of polyether, polyester, and polyamide, and methoxy polyethylene glycol(meth)acrylate, etc. These compounds may be used alone or in combination of two or more thereof.

Examples of the conductive polymer include, for example, a polyaniline, polypyrrole, and polythiophene, etc.

Examples of the conductive substance include, for example, a tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, and alloys or mixtures thereof.

As the resin component to be used in the antistatic resin and the conductive resin, general-purpose resins, such as polyester, acrylic, polyvinyl, urethane, melamine, and epoxy, are used. Herein, a polymer-type antistatic agent may not contain the resin component. It is also possible to contain, as a cross-linking agent, a methylolated or alkylolated melamine, urea, glyoxal, or acrylamide compound, epoxy compound, or isocyanate compound in the antistatic resin component.

In a method of forming an antistatic layer, the layer is formed, for example, by diluting the antistatic resin, the conductive polymer, or the conductive resin with an organic solvent or a solvent such as water, by applying the application liquid to a plastic film, and by drying the applied liquid.

Examples of an organic solvent to be used for the formation of the antistatic layer include, for example, methyl ethyl ketone, acetone, ethyl acetate, tetrahydrofuran, dioxane, cyclohexanone, n-hexane, toluene, xylene, methanol, ethanol, n-propanol, and isopropanol, etc. These solvents may be used alone or in combination of two or more thereof.

A publicly-known application method is appropriately adopted for the formation of the antistatic layer, and specific examples of the method include, for example, a roll coating method, gravure coating method, reverse coating method, roll brush method, spray coating method, air knife coating method, impregnation method, and curtain coating method.

The thickness of the layer of the antistatic resin, conductive polymer, or conductive resin, is usually within a range of 0.01 μm to 5 μm, and preferably within a range of approximately 0.03 μm to 1 μm.

Examples of a method of vapor-depositing or plating the conductive substance include, for example, a vacuum vapor deposition method, sputtering method, ion plating method, chemical vapor deposition method, spray pyrolysis method, chemical plating method, and electroplating method, etc.

The thickness of the conductive substance layer is usually within a range of 2 nm to 1000 nm, and preferably within a range of 5 nm to 500 nm.

The aforementioned antistatic agents are appropriately adopted as the kneading-type antistatic agent. The blending amount of the kneading-type antistatic agent is less than or equal to 20% by mass, and preferably within a range of 0.05% by mass to 10% by mass, based on the total mass of the plastic film. The kneading method is not particularly limited as far as the antistatic agent can be uniformly mixed in a resin to be used in the plastic film, and for example, a heating roller, Banbury mixer, pressurized kneader, twin-screw kneader, or the like, can be used.

In order to protect the pressure-sensitive adhesive surface, a release liner can be attached, if necessary, to the surface of the pressure-sensitive adhesive layer in the pressure-sensitive adhesive sheet of the present embodiment and the later-described surface protective sheet and optical surface protective sheet.

Paper or a plastic film can be used as a material for forming the release liner, but a plastic film is preferably used because it is excellent in surface smoothness. The film is not particularly limited as far as it can protect the pressure-sensitive adhesive layer. Examples of the film include, for example, a polyethylene film, polypropylene film, polybutene film, polybutadiene film, polymethylpentene film, polyvinylchloride film, vinylchloride copolymer film, polyethylene terephthalate film, polybutylene terephthalate film, polyurethane film, and ethylene-vinylacetate copolymer film, etc.

The thickness of the release liner is usually within a range of 5 μm to 200 μm, and preferably within a range of approximately 10 μm to 100 μm. When the thickness is within the aforementioned range, the release liner is excellent in the workability for attaching to the pressure-sensitive adhesive layer and the workability for releasing therefrom, and hence the release liner is preferred. The release liner can also be subjected to, if necessary: a mold-release and antifouling treatment using a release agent, such as a silicone release agent, fluorine release agent, long-chain alkyl release agent, or fatty acid amide release agent, and a silica powder; and an antistatic treatment, such as an application type, kneading type, vapor deposition type, or the like.

The pressure-sensitive adhesive sheet of the present embodiment has the property that the pressure-sensitive adhesive force at high-speed peeling is small and the adhesive force at low-speed peeling is sufficiently high to a degree in which a defect such as pop-off or peeling is not caused. The pressure-sensitive adhesive force of the peelable pressure-sensitive adhesive sheet of the embodiment, occurring at high-speed peeling, can be evaluated by a 180° peeling pressure-sensitive adhesive force test in which the sheet is peeled at tensile speed of 30 m/min and at a peel angle of 180°. In particular, the pressure-sensitive adhesive force smaller than or equal to 1.5 N/25 mm is determined to be good. The 180° peeling pressure-sensitive adhesive force is preferably 1.3 N/25 mm or smaller, and more preferably 1.0 N/25 mm or smaller. The lower limit of the 180° peeling pressure-sensitive adhesive force is not particularly required, but it is usually 0.1 N/25 mm or larger, and preferably 0.2 N/25 mm or larger. The 180° peeling pressure-sensitive adhesive force test is performed in accordance with the method and conditions described in the later-described Examples.

The pressure-sensitive adhesive force of the pressure-sensitive adhesive sheet of the present embodiment, occurring at low-speed peeling, can be evaluated by a period of time required for peeling in a constant load peeling test. A peeling time, occurring when a constant load of 1.2 g is applied to a pressure-sensitive adhesive sheet having a width of 10 mm×a length of 50 mm in the 90° direction, is determined to be good when it is 100 seconds or longer. The peeling time in the constant load peeling test is preferably 300 seconds or longer, and more preferably 400 seconds or longer. The upper limit of the peeling time in the constant load peeling test is not particularly required, but it is usually 1500 seconds or shorter. The constant load peeling test is performed in accordance with the method and conditions described in the later-described Examples.

Further, the pressure-sensitive adhesive sheet of the present embodiment has the property that the transparency is high. The transparency of the peelable pressure-sensitive adhesive sheet of the embodiment can be evaluated by a haze. The transparency is determined to be good particularly when a haze is less than 7.3%. The haze is preferably less than 5%, and more preferably less than 3.5%. A haze test is performed in accordance with the method and conditions described in the later-described Examples.

The pressure-sensitive adhesive sheet of the present embodiment has the aforementioned properties, and can be used as a peelable pressure-sensitive adhesive sheet particularly exhibiting the peelability. Further, by exhibiting the properties, the pressure-sensitive adhesive sheet can be used as a surface protective sheet, in particular, as a surface protective sheet film to be used for protecting the surface of an optical member, such as a polarizing plate, wavelength plate, optical compensation film, reflective sheet, or the like, and can also be used as an optical film with surface protective sheet in which an optical surface protective sheet is attached to the optical member.

### [Surface Protective Sheet]

As described above, the pressure-sensitive adhesive sheet of the present embodiment has the property that the pressure-sensitive adhesive force at high-speed peeling is small and the adhesive force at low-speed peeling is high to a degree in which a defect such as pop-off or peeling is not caused, and hence the sheet can be preferably used as a surface protective sheet for protecting the surfaces of various objects to be protected. Examples of the objects to be protected, to which the surface protective sheet of the embodiment can be applied, include automobiles (coatings of the bodies), house and building materials, and home electronic appliances, etc., in which members made of the following materials are used, the materials including: various resins such as PE (polyethylene), PP (polypropylene), ABS (acrylonitrile-butadiene-styrene copolymer), SBS (styrene-butadiene-styrene block copolymer), PC (polycarbonate), PVC (polyvinyl chloride), and acrylic resins such as PMMA (polymethyl methacrylate resin); metals such as SUS (stainless steel) and aluminum; glass; and the like.

When the pressure-sensitive adhesive sheet of the present embodiment is used as a surface protective sheet, the aforementioned peelable pressure-sensitive adhesive sheet can be used as it is. When it is used particularly as a surface protective sheet, however, it is preferable to use, as the supporting body, a polyolefin film, polyester film, or polyvinylchloride film, each having a thickness of 10 μm to 100 μm, from the viewpoint of the prevention of a scratch or stain and processability. Additionally, it is preferable to set the thickness of the pressure-sensitive adhesive layer to be within a range of approximately 3 μm to 60 μm.

### [Optical Surface Protective Sheet]

The surface protective sheet of the present embodiment has the property that the transparency is high, in addition to the aforementioned pressure-sensitive adhesive property, and hence the sheet can be preferably used as an optical surface protective sheet to be used for protecting the surface of an optical film. Examples of the optical film, to which the optical surface protective film of the embodiment can be applied, include a polarizing plate, wavelength plate, optical compensation film, light diffusion sheet, reflective sheet, antireflection sheet, brightness enhancement film, and transparent conductive film (ITO film), etc., which can be used in image display apparatuses, such as a liquid crystal display, plasma display, and organic EL display.

The optical surface protective sheet of the present embodiment can be used for the protection of: optical films such as the polarizing plate, when they are shipped in the manufacturer thereof; optical films, when a display apparatus (liquid crystal module) is manufactured in the manufacturer of image display apparatuses such as a liquid crystal display apparatus; and further optical films in various steps, such as a punching step and cutting step.

When the peelable pressure-sensitive adhesive sheet of the present embodiment is used as an optical surface protective sheet, the aforementioned peelable pressure-sensitive adhesive sheet can be used as it is. When the sheet is used particularly as an optical surface protective sheet, however, it is preferable to use, as the supporting body, a polyolefin film, polyethylene terephthalate film, polybutylene terephthalate film, or polyethylene naphthalate film, each having a thickness of 10 μm to 100 μm, from the viewpoints of the prevention of a scratch or stain, processability, and transparency. Additionally, it is preferable to set the thickness of the pressure-sensitive adhesive layer to be within a range of approximately 3 μm to 40 μm.

[Optical Film with Surface Protective Sheet]

In the present embodiment, an optical film with surface protective sheet is provided, in which an optical surface protective sheet is attached to the aforementioned optical film. The optical film with surface protective sheet of the embodiment is made by attaching the aforementioned optical surface protective sheet to one or both surfaces of the optical film. In the optical film with surface protective sheet of the embodiment, a scratch can be prevented from being caused and dust and dirt can be prevented from adhering to the film, which may occur: when optical films, such as the aforementioned polarizing plate, are shipped in the manufacturer of the optical films; when a display apparatus (liquid crystal module) is manufactured in the manufacturer of image display apparatuses, such as a liquid crystal display; and further in various steps, such as a punching step and cutting step. Further, the optical surface protective sheet has high transparency, and hence inspection can be performed while the sheet is being attached. Furthermore, when the optical surface protective sheet becomes unnecessary, it can be easily peeled, without damaging the optical film and an image display apparatus.

As described above, the pressure-sensitive adhesive composition according to the present embodiment include: as a pressure-sensitive adhesive composite, 100 parts by mass of a polymer (A) having a glass transition temperature lower than 0° C.; and 0.05 parts by mass to 3 parts by mass of a (meth)acrylic polymer (B) containing, as a monomer unit, a (meth)acrylic monomer having a weight average molecular weight (M_{WB}) of 1000≦M_{WB}<50000 and a glass transition temperature of 30 to 300° C., and hence, when a pressure-sensitive adhesive layer is formed by using the pressure-sensitive adhesive composition, the adhesive force at low-speed peeling can be made high to a degree in which a defect, such as pop-off or peeling, is not caused, and in particular, the transparency can be improved. Further, by using an organopolysiloxane compound (C) having a polyoxyalkylene chain, the pressure-sensitive adhesive force at high-speed peeling can be suppressed.

A peelable pressure-sensitive adhesive sheet, in which a pressure-sensitive adhesive layer, made of the pressure-sensitive adhesive composition of the present embodiment, is formed on a supporting body, has such excellent properties, and hence it can be used as a surface protective sheet, and in particular, as an optical film surface protective sheet to be used for protecting the surface of an optical film. Further, the peelable pressure-sensitive adhesive sheet can also be used as an optical film with surface protective sheet in which the optical surface protective sheet is attached to an optical film.

### EXAMPLES

Hereinafter, the present invention will be described in detail based on Examples, but the invention should not be limited at all by these Examples.

Components of the pressure-sensitive adhesive compositions of Examples 1 to 9 and Comparative Examples 1 to 4 are shown in Table 2.

TABLE 2

| | | | | | | | ORGANOPOLYSILOXANE | |
|---|---|---|---|---|---|---|---|---|
| | | | | | | | COMPOUND (C) HAVING | |
| | POLYMER (A) | | (METH)ACRYLIC POLYMER (B) | | | | POLYOXYALKYLENE CHAIN | |
| | COMPOSITION | NUMBER | COMPOSITION | | Tg | NUMBER | | NUMBER |
| | (wt %) | OF PARTS | (wt %) | Mw | (° C.) | OF PARTS | NAME | OF PARTS |
| EXAMPLE 1 | 2EHA/HEA = | 100 | DCPMA/MMA = | 4300 | 130 | 1 | KF6004 | 0.5 |
| | 96/4 | | 40/60 | | | | | |
| EXAMPLE 2 | 2EHA/HEA = | 100 | DCPMA/MMA = | 4300 | 130 | 2 | KF6004 | 0.5 |
| | 96/4 | | 40/60 | | | | | |
| EXAMPLE 3 | 2EHA/HEA = | 100 | IBXMA/MMA = | 4300 | 130 | 1 | KF6004 | 0.5 |
| | 96/4 | | 40/60 | | | | | |
| EXAMPLE 4 | 2EHA/HEA = | 100 | CHMA/IBMA = | 4000 | 59 | 1 | KF6004 | 0.5 |
| | 96/4 | | 60/40 | | | | | |
| EXAMPLE 5 | 2EHA/HEA = | 100 | MMA = 100 | 4400 | 105 | 1 | KF6004 | 0.5 |
| | 96/4 | | | | | | | |
| EXAMPLE 6 | 2EHA/HEA = | 100 | DCPMA/NVP = | 24000 | 117 | 1 | KF6004 | 0.5 |
| | 96/4 | | 60/40 | | | | | |
| EXAMPLE 7 | 2EHA/HEA = | 100 | DCPMA/HEMA = | 5500 | 139 | 1 | KF6004 | 0.5 |
| | 96/4 | | 80/20 | | | | | |
| EXAMPLE 8 | 2EHA/HEA = | 100 | DCPMA/MMA = | 33000 | 144 | 1 | KF6004 | 0.5 |
| | 96/4 | | 60/40 | | | | | |
| EXAMPLE 9 | 2EHA/HEA = | 100 | DCPMA/MMA = | 4300 | 130 | 1 | KF353 | 0.5 |
| | 96/4 | | 40/60 | | | | | |
| COMPARATIVE | 2EHA/HEA = | 100 | — | — | — | — | KF6004 | 0.5 |
| EXAMPLE 1 | 96/4 | | | | | | | |
| COMPARATIVE | 2EHA/HEA = | 100 | DCPMA/MMA = | 4300 | 130 | 5 | KF6004 | 0.5 |
| EXAMPLE 2 | 96/4 | | 40/60 | | | | | |
| COMPARATIVE | 2EHA/HEA = | 100 | DCPMA/MMA = | 4300 | 130 | 1 | GP-3000 | 0.5 |
| EXAMPLE 3 | 96/4 | | 40/60 | | | | | |
| COMPARATIVE | 2EHA/HEA = | 100 | DCPMA/MMA = | 4300 | 130 | 1 | 50HB- | 0.5 |
| EXAMPLE 4 | 96/4 | | 40/60 | | | | 2000 | |

| | CROSS- | CROSS- | | | |
|---|---|---|---|---|---|
| | LINKING | LINKING | IONIC | | THICKNESS OF |
| | CATALYST | AGENT | COMPOUND | GEL | PRESSURE-SENSITIVE |
| | NUMBER | NUMBER | NUMBER | FRACTION | ADHESIVE LAYER |
| | OF PARTS | OF PARTS | OF PARTS | (%) | (μm) |
| EXAMPLE 1 | 0.03 | 1.5 | 0.06 | 91.6 | 15 |
| EXAMPLE 2 | 0.03 | 2.5 | 0.06 | 91.7 | 15 |
| EXAMPLE 3 | 0.03 | 2.5 | 0.06 | 92.6 | 15 |
| EXAMPLE 4 | 0.03 | 2.5 | 0.06 | 91.8 | 15 |
| EXAMPLE 5 | 0.03 | 2.5 | 0.06 | 92.1 | 15 |
| EXAMPLE 6 | 0.03 | 2.5 | 0.06 | 92.3 | 15 |
| EXAMPLE 7 | 0.03 | 2.5 | 0.06 | 92.7 | 15 |
| EXAMPLE 8 | 0.03 | 2.5 | 0.06 | 92.6 | 15 |
| EXAMPLE 9 | 0.03 | 2.5 | 0.06 | 92.9 | 15 |
| COMPARATIVE | 0.03 | 2.5 | 0.06 | 94.4 | 15 |
| EXAMPLE 1 | | | | | |
| COMPARATIVE | 0.03 | 2.5 | 0.06 | 89.3 | 15 |
| EXAMPLE 2 | | | | | |
| COMPARATIVE | 0.03 | 2.5 | 0.06 | 93.9 | 15 |
| EXAMPLE 3 | | | | | |
| COMPARATIVE | 0.03 | 2.5 | 0.06 | 93.7 | 15 |
| EXAMPLE 4 | | | | | |

The abbreviations in Table 2 represent the following compounds.

2EHA: 2-Ethylhexyl Acrylate

HEA: 2-Hydroxyethyl Acrylate

DCPMA: Dicyclopentanyl Methacrylate

MMA: Methyl Methacrylate

NVP: N-Vinyl-2-Pyrrolidone

IBXMA: Isobornyl Methacrylate

CHMA: Cyclohexyl Methacrylate

IBMA: Isobutyl Methacrylate

HEMA: 2-Hydroxyethyl Methacrylate

### (Preparation of (Meth)Acrylic Polymer (a) (2EHA/HEA=96/4))

Into a four-necked flask provided with a stirring blade, thermometer, nitrogen gas inlet pipe, cooler, and dropping funnel, 96 parts by mass of 2-ethylhexyl acrylate (2EHA), 4 parts by mass of 2-hydroxyethyl acrylate (HEA), 0.2 parts by mass of 2,2′-azobisisobutyronitriles as a polymerization initiator, and 150 parts by mass of ethyl acetate were put. A polymerization reaction was performed for 6 hours by introducing nitrogen gas while the liquid in the flask was being gently stirred and by maintaining the temperature of the liquid at approximately 65° C., thereby preparing an acrylic polymer (A) solution (40% by mass). The glass transition temperature of this acrylic polymer (A) was −68° C. by calculating from the Fox Equation, and the weight average molecular weight thereof was 550,000.

### (Preparation of (Meth)Acrylic Polymer 1 (DCPMA/MMA=40/60) as (B) Component)

Into a four-necked flask provided with a stirring blade, thermometer, nitrogen gas inlet pipe, cooler, and dropping funnel, 100 parts by mass of toluene, 40 parts by mass of dicyclopentanyl methacrylate (DCPMA) (product name: FA-513M, made by Hitachi Chemical Co., Ltd.), 60 parts by mass of methyl methacrylate (MMA), and 3.5 parts by mass of methyl thioglycolate as a chain transfer agent, were put. After they were stirred under a nitrogen atmosphere at 70° C. for 1 hour, 0.2 parts by mass of azobisisobutyronitrile were put therein as a thermal polymerization initiator to react with them at 70° C. for 2 hours, and subsequently they were reacted together at 80° C. for 4 hours and further reacted together at 90° C. for 1 hour. The glass transition temperature of the obtained (meth)acrylic polymer 1 was 130° C. by calculating from the Fox Equation, and the weight average molecular weight thereof was 4300.

### (Preparation of (Meth)Acrylic Polymer 2 (IBXMA/MMA=40/60) as (B) Component)

Into a four-necked flask provided with a stirring blade, thermometer, nitrogen gas inlet pipe, cooler, and dropping funnel, 100 parts by mass of toluene, 40 parts by mass of isobornyl methacrylate (IBXMA), 60 parts by mass of methyl methacrylate (MMA), and 3 parts by mass of thioglycolic acid as a chain transfer agent, were put. After they were stirred under a nitrogen atmosphere at 70° C. for 1 hour, 0.2 parts by mass of azobisisobutyronitrile were put therein as a thermal polymerization initiator to react with them at 70° C. for 2 hours, and subsequently they were reacted together at 80° C. for 2 hours. The glass transition temperature of the obtained (meth)acrylic polymer 2 was 130° C. by calculating from the Fox Equation, and the weight average molecular weight thereof was 4300.

### (Preparation of (Meth)Acrylic Polymer 3 (CHMA/IBMA=60/40) as (B) Component)

Into a four-necked flask provided with a stirring blade, thermometer, nitrogen gas inlet pipe, cooler, and dropping funnel, 60 parts by mass of cyclohexyl methacrylate (CHMA), 40 parts by mass of isobutyl methacrylate (IBMA), and 4 parts by mass of thioglycolic acid as a chain transfer agent, were put. After they were stirred under a nitrogen atmosphere at 70° C. for 1 hour, the liquid was heated to 90° C., and 0.005 parts by mass of “PERHEXYL O” (made by NOF CORPORATION) and 0.01 parts by mass of “PERHEXYL D” (made by NOF CORPORATION) were mixed therein as thermal polymerization initiators. After being further stirred at 90° C. for 1 hour, the mixture was heated to 150° C. in 1 hour and stirred at the temperature for 1 hour. Subsequently, the mixture was heated to 170° C. in 1 hour and stirred at the temperature for 60 minutes. The pressure under which the mixture was put was reduced at 170° C. and the mixture was stirred for 1 hour to remove remaining monomers, thereby allowing a (meth)acrylic polymer 3 to be obtained. The glass transition temperature of the obtained (meth)acrylic polymer 3 was 59° C. by calculating from the Fox Equation, and the weight average molecular weight thereof was 4000.

### (Preparation of (Meth)Acrylic Polymer 4 (MMA=100) as (B) Component)

Into a four-necked flask provided with a stirring blade, thermometer, nitrogen gas inlet pipe, cooler, and dropping funnel, 100 parts by mass of toluene, 100 parts by mass of methyl methacrylate (MMA), and 3 parts by mass of thioglycolic acid as a chain transfer agent, were put. After they were stirred under a nitrogen atmosphere at 70° C. for 1 hour, 0.2 parts by mass of azobisisobutyronitrile were put therein as a thermal polymerization initiator to react with them at 70° C. for 2 hours, and subsequently they were reacted together at 80° C. for 4 hours. The glass transition temperature of the obtained (meth)acrylic polymer 4 was 105° C. by calculating from the Fox Equation, and the weight average molecular weight thereof was 4400.

### (Preparation of (Meth)Acrylic Polymer 5 (DCPMA/NVP=60/40) as (B) Component)

Into a four-necked flask provided with a stirring blade, thermometer, nitrogen gas inlet pipe, cooler, and dropping funnel, 100 parts by mass of toluene, 60 parts by mass of dicyclopentanyl methacrylate (DCPMA) (product name: FA-513M, made by Hitachi Chemical Co., Ltd.), 40 parts by mass of N-vinylpyrrolidone (NVP), and 2 parts by mass of thioglycolic acid as a chain transfer agent, were put. After they were stirred under a nitrogen atmosphere at 70° C. for 1 hour, 0.2 parts by mass of azobisisobutyronitrile were put therein as a thermal polymerization initiator to react with them at 70° C. for 2 hours, and subsequently they were reacted together at 80° C. for 2 hours. Thereafter, the reaction liquid was put under a temperature atmosphere of 130° C. to dry and remove the toluene, chain transfer agent, and unreacted monomers, thereby allowing a solid (meth)acrylic polymer 5 to be obtained. The glass transition temperature of the obtained (meth)acrylic polymer 5 was 117° C. by calculating from the Fox Equation, and the weight average molecular weight thereof was 24000.

### (Preparation of (Meth)Acrylic Polymer 6 (DCPMA/HEMA=80/20) as (B) Component)

Into a four-necked flask provided with a stirring blade, thermometer, nitrogen gas inlet pipe, cooler, and dropping funnel, 100 parts by mass of toluene, 80 parts by mass of dicyclopentanyl methacrylate (DCPMA) (product name: FA-513M, made by Hitachi Chemical Co., Ltd.), 20 parts by mass of hydroxyethyl methacrylate (HEMA), and 2 parts by mass of thioglycolic acid as a chain transfer agent, were put. After they were stirred under a nitrogen atmosphere at 70° C. for 1 hour, 0.2 parts by mass of azobisisobutyronitrile were put therein as a thermal polymerization initiator to react with them at 70° C. for 2 hours, and subsequently they were reacted together at 80° C. for 4 hours and further reacted together at 90° C. for 1 hour. The glass transition temperature of the obtained (meth)acrylic polymer 6 was 139° C. by calculating from the Fox Equation, and the weight average molecular weight thereof was 5500.

### (Preparation of (Meth)Acrylic Polymer 7 (DCPMA/MMA=60/40) as (B) Component)

Into a four-necked flask provided with a stirring blade, thermometer, nitrogen gas inlet pipe, cooler, and dropping funnel, 100 parts by mass of toluene, 60 parts by mass of dicyclopentanyl methacrylate (DCPMA) (product name: FA-513M, made by Hitachi Chemical Co., Ltd.), 40 parts by mass of methyl methacrylate (MMA), and 0.35 parts by mass of α-thioglycerol as a chain transfer agent, were put. After they were stirred under a nitrogen atmosphere at 70° C. for 1 hour, 0.2 parts by mass of azobisisobutyronitrile were put therein as a thermal polymerization initiator to react with them at 70° C. for 2 hours, and subsequently they were reacted together at 80° C. for 5 hours. The glass transition temperature of the obtained (meth)acrylic polymer 7 was 144° C. by calculating from the Fox Equation, and the weight average molecular weight thereof was 33000.

### Example 1

### Preparation of Pressure-Sensitive Adhesive Composition

A pressure-sensitive adhesive composition (1) was prepared by adding, to 500 parts by mass of a solution (100 parts by mass of the (meth)acrylic polymer (a)) in which a (meth)acrylic polymer (a) solution (35% by mass) was diluted with ethyl acetate to 20% by mass, 1 part by mass of the (meth)acrylic polymer 1, 0.5 parts by mass of an organopolysiloxane compound having a polyoxyalkylene chain (product name: KF6004 made by Shin-Etsu Chemical Co., Ltd., which corresponds to Formula (C3)), 2.0 parts by mass of CORONATE L (75% by mass of the solid of an adduct of trimethylolpropane/tolylene diisocyanate trimer are dissolved in an ethyl acetate solution, made by NIPPON POLYURETHANE INDUSTRY CO., LTD.) as a cross-linking agent, 3 parts by mass of an ethyl acetate solution in which 1% by mass of the solid of dioctyl tin dilaurate is dissolved, as a cross-linking catalyst, and 0.06 parts by mass of bis(trifluoromethane sulfonyl)imidelithium (LiTFSI) (made by Tokyo Chemical Industry Co., Ltd.) as an ionic compound, and then by mixing and stirring them at 25° C. for approximately 5 minutes.

### (Production of Pressure-Sensitive Adhesive Sheet)

A pressure-sensitive adhesive layer having a thickness of 15 μm was formed by applying the aforementioned pressure-sensitive adhesive composition (1) to a surface of a polyethylene terephthalate film with an antistatic treatment layer (product name: Diafoil T100G38 made by Mitsubishi Plastics, Inc., thickness: 38 μm), the surface being opposite to the antistatic treated surface, and then by heating it at 130° C. for 2 minutes. Subsequently, a pressure-sensitive adhesive sheet was produced by attaching the silicone-treated surface of a release liner (polyethylene terephthalate film having a thickness of 25 μm, one surface of which has been subjected to a silicone treatment) to the surface of the aforementioned pressure-sensitive adhesive layer.

### Example 2

### Preparation of Pressure-Sensitive Adhesive Composition

A pressure-sensitive adhesive composition (2) was prepared in the same way as that in Example 1, except that: instead of 1 part by mass of the (meth)acrylic polymer 1, 2 parts by mass of it was used; and instead of 2.0 parts by mass of the CORONATE L (75% by mass of the solid of an adduct of trimethylolpropane/tolylene diisocyanate trimer are dissolved in an ethyl acetate solution, made by NIPPON POLYURETHANE INDUSTRY CO., LTD.), 3.3 parts by mass of the CORONATE L (75% by mass of the solid of an adduct of trimethylolpropane/tolylene diisocyanate trimer are dissolved in an ethyl acetate solution, made by NIPPON POLYURETHANE INDUSTRY CO., LTD.) were used.

### (Production of Pressure-Sensitive Adhesive Sheet)

A pressure-sensitive adhesive sheet was produced in the same way as that in Example 1, except that, instead of the pressure-sensitive adhesive composition (1), the pressure-sensitive adhesive composition (2) was used.

### Example 3

### Preparation of Pressure-Sensitive Adhesive Composition

A pressure-sensitive adhesive composition (3) was prepared in the same way as that in Example 2, except that, instead of 2 parts by mass of the (meth)acrylic polymer 1, 1 part by mass of the (meth)acrylic polymer 2 was used.

### (Production of Pressure-Sensitive Adhesive Sheet)

A pressure-sensitive adhesive sheet was produced in the same way as that in Example 2, except that, instead of the pressure-sensitive adhesive composition (2), the pressure-sensitive adhesive composition (3) was used.

### Example 4

### Preparation of Pressure-Sensitive Adhesive Composition

A pressure-sensitive adhesive composition (4) was prepared in the same way as that in Example 2, except that, instead of 2 parts by mass of the (meth)acrylic polymer 1, 1 part by mass of the (meth)acrylic polymer 3 was used.

### (Production of Pressure-Sensitive Adhesive Sheet)

A pressure-sensitive adhesive sheet was produced in the same way as that in Example 2, except that, instead of the pressure-sensitive adhesive composition (2), the pressure-sensitive adhesive composition (4) was used.

### Example 5

### Preparation of Pressure-Sensitive Adhesive Composition

A pressure-sensitive adhesive composition (5) was prepared in the same way as that in Example 2, except that, instead of 2 parts by mass of the (meth)acrylic polymer 1, 1 part by mass of the (meth)acrylic polymer 4 was used.

### (Production of Pressure-Sensitive Adhesive Sheet)

A pressure-sensitive adhesive sheet was produced in the same way as that in Example 2, except that, instead of the pressure-sensitive adhesive composition (2), the pressure-sensitive adhesive composition (5) was used.

### Example 6

### Preparation of Pressure-Sensitive Adhesive Composition

A pressure-sensitive adhesive composition (6) was prepared in the same way as that in Example 2, except that, instead of 2 parts by mass of the (meth)acrylic polymer 1, 1 part by mass of the (meth)acrylic polymer 5 was used.

### (Production of Pressure-Sensitive Adhesive Sheet)

A pressure-sensitive adhesive sheet was produced in the same way as that in Example 2, except that, instead of the pressure-sensitive adhesive composition (2), the pressure-sensitive adhesive composition (6) was used.

### Example 7

### Preparation of Pressure-Sensitive Adhesive Composition

A pressure-sensitive adhesive composition (7) was prepared in the same way as that in Example 2, except that, instead of 2 parts by mass of the (meth)acrylic polymer 1, 1 part by mass of the (meth)acrylic polymer 6 was used.

### (Production of Pressure-Sensitive Adhesive Sheet)

A pressure-sensitive adhesive sheet was produced in the same way as that in Example 2, except that, instead of the pressure-sensitive adhesive composition (2), the pressure-sensitive adhesive composition (7) was used.

### Example 8

### Preparation of Pressure-Sensitive Adhesive Composition

A pressure-sensitive adhesive composition (8) was prepared in the same way as that in Example 2, except that, instead of 2 parts by mass of the (meth)acrylic polymer 1, 1 part by mass of the (meth)acrylic polymer 7 was used.

### (Production of Pressure-Sensitive Adhesive Sheet)

A pressure-sensitive adhesive sheet was produced in the same way as that in Example 2, except that, instead of the pressure-sensitive adhesive composition (2), the pressure-sensitive adhesive composition (8) was used.

### Example 9

### Preparation of Pressure-Sensitive Adhesive Composition

A pressure-sensitive adhesive composition (9) was prepared in the same way as that in Example 1, except that: instead of 0.5 parts by mass of the organopolysiloxane compound having a polyoxyalkylene chain (product name: KF6004 made by Shin-Etsu Chemical Co., Ltd., which corresponds to Formula (C3)), 0.5 parts by mass of an organopolysiloxane compound having a polyoxyalkylene chain (product name: KF353 made by Shin-Etsu Chemical Co., Ltd., which corresponds to Formula (C1)) were used; and instead of 2.0 parts by mass of the CORONATE L (75% by mass of the solid of an adduct of trimethylolpropane/tolylene diisocyanate trimer are dissolved in an ethyl acetate solution, made by NIPPON POLYURETHANE INDUSTRY CO., LTD.), 3.3 parts by mass of the CORONATE L (75% by mass of the solid of an adduct of trimethylolpropane/tolylene diisocyanate trimer are dissolved in an ethyl acetate solution, made by NIPPON POLYURETHANE INDUSTRY CO., LTD.) were used.

### (Production of Pressure-Sensitive Adhesive Sheet)

A pressure-sensitive adhesive sheet was produced in the same way as that in Example 1, except that, instead of the pressure-sensitive adhesive composition (1), the pressure-sensitive adhesive composition (9) was used.

### Comparative Example 1

### Preparation of Pressure-Sensitive Adhesive Composition

A pressure-sensitive adhesive composition (10) was prepared in the same way as that in Example 2, except that the (meth)acrylic polymer 1 was not used.

### (Production of Pressure-Sensitive Adhesive Sheet)

A pressure-sensitive adhesive sheet was produced in the same way as that in Example 2, except that, instead of the pressure sensitive adhesive composition (2), the pressure-sensitive adhesive composition (10) was used.

### Comparative Example 2

### Preparation of Pressure-Sensitive Adhesive Composition

A pressure-sensitive adhesive composition (11) was prepared in the same way as that in Example 2, except that, instead of 2 parts by mass of the (meth)acrylic polymer 1, 5 parts by mass of the (meth)acrylic polymer 1 was used.

### (Production of Pressure-Sensitive Adhesive Sheet)

A pressure-sensitive adhesive sheet was produced in the same way as that in Example 2, except that, instead of the pressure-sensitive adhesive composition (2), the pressure-sensitive adhesive composition (11) was used.

### Comparative Example 3

### Preparation of Pressure-Sensitive Adhesive Composition

A pressure-sensitive adhesive composition (12) was prepared in the same way as that in Example 1, except that: instead of 0.5 parts by mass of the organopolysiloxane compound having a polyoxyalkylene chain (product name: KF6004 made by Shin-Etsu Chemical Co., Ltd., which corresponds to Formula (C3)), 0.5 parts by mass of propylene glycol (number average molecular weight: 3000, triol type, product name: GP-3000 made by Sanyo Chemical Industries, Ltd.) were used; and instead of 2.0 parts by mass of the CORONATE L (75% by mass of the solid of an adduct of trimethylolpropane/tolylene diisocyanate trimer are dissolved in an ethyl acetate solution, made by NIPPON POLYURETHANE INDUSTRY CO., LTD.), 3.3 parts by mass of the CORONATE L (75% by mass of the solid of an adduct of trimethylolpropane/tolylene diisocyanate trimer are dissolved in an ethyl acetate solution, made by NIPPON POLYURETHANE INDUSTRY CO., LTD.) were used.

### (Production of Pressure-Sensitive Adhesive Sheet)

A pressure-sensitive adhesive sheet was produced in the same way as that in Example 1, except that, instead of the pressure-sensitive adhesive composition (1), the pressure-sensitive adhesive composition (12) was used.

### Comparative Example 4

### Preparation of Pressure-Sensitive Adhesive Composition

A pressure-sensitive adhesive composition (13) was prepared in the same way as that in Example 1, except that: instead of 0.5 parts by mass of the organopolysiloxane compound having a polyoxyalkylene chain (product name: KF6004 made by Shin-Etsu Chemical Co., Ltd., which corresponds to Formula (C3)), 0.5 parts by mass of polyethylene glycol-polypropylene glycol (number average molecular weight: 2300, monobutyl ether type, product name: 50HB-2000 made by Sanyo Chemical Industries, Ltd.) were used; and instead of 2.0 parts by mass of the CORONATE L (75% by mass of the solid of an adduct of trimethylolpropane/tolylene diisocyanate trimer are dissolved in an ethyl acetate solution, made by NIPPON POLYURETHANE INDUSTRY CO., LTD.), 3.3 parts by mass of the CORONATE L (75% by mass of the solid of an adduct of trimethylolpropane/tolylene diisocyanate trimer are dissolved in an ethyl acetate solution, made by NIPPON POLYURETHANE INDUSTRY CO., LTD.) were used.

### (Production of Pressure-Sensitive Adhesive Sheet)

A pressure-sensitive adhesive sheet was produced in the same way as that in Example 1, except that, instead of the pressure-sensitive adhesive composition (1), the pressure-sensitive adhesive composition (13) was used.

### (Test Method)

### <Measurement of Molecular Weight>

The weight average molecular weights of a polymer and a (meth)acrylic copolymer were measured by using a GPC apparatus (product name: HLG-8220GPC, made by TOSOH CORP.). Measurement conditions were as follows and the molecular weights were determined by standard polystyrene conversion.
Sample concentration: 0.2 wt % (tetrahydrofuran (THF) solution)
Sample injection volume: 10 μl
Eluent: THF
Flow Rate: 0.6 ml/min
Measuring temperature: 40° C.
Column:
Sample column: TSKguardcolumn SuperHZ-H (1 column)+TSKgel SuperHZM-H (2 columns)
Reference column: TSKgel SuperH-RC (1 column)
Detector: differential refractometer (RI)

Only the (meth)acrylic copolymer 5 (DCPMA/NVP=60/40) was measured in the following conditions.
Sample concentration: 0.1 wt % (THF/N,N-dimethylformamide (DMF) solution)
Sample injection volume: 20 μl
Eluent: 10 mM-LiBr+10 mM-phosphoric acid/DMF
Flow Rate: 0.4 ml/min
Measuring temperature: 40° C.
Column:
Sample column; TSK guardcolumn SuperAW-H (1 column)+TSKgel SuperAWM-H+TSKgel SuperAW4000+TSKgel SuperAW2500
Reference column; TSKgel SuperH-RC (1 column)
Detector: differential refractometer (RI)

### (Measurement of Ratio of Solvent-Insoluble Component)

The ratio (gel fraction) of a solvent-insoluble component was determined as follows: 0.1 g of a sampled pressure-sensitive adhesive composition was weighed precisely (mass before immersion) and then dipped in approximately 50 ml of ethyl acetate at room temperature (20 to 25° C.) for 1 week; a solvent (ethyl acetate) insoluble component was taken out to be dried at 130° C. for 2 hours and then weighed (mass after immersion and drying); and the ratio was calculated by using an equation for calculating a “ratio of solvent-insoluble component (by mass)=[(mass after immersion and drying)/(mass before immersion)]×100”.

### (Low-Speed Peeling Test: Constant Load Peeling)

An evaluation sample (optical film with surface protective sheet) was produced as follows: the pressure-sensitive adhesive sheet according to each of Examples and Comparative Examples was cut into a size of 10 mm in width×60 mm in length; and after the release liner was peeled, the sheet was pressure-attached to the surface of a triacetyl cellulose polarizing plate (product name: SEG1425DU made by NITTO DENKO CORPORATION, width: 70 mm, length: 100 mm) with a hand roller and then laminated in the pressure-bonding conditions of 0.25 MPa and 0.3 m/min.

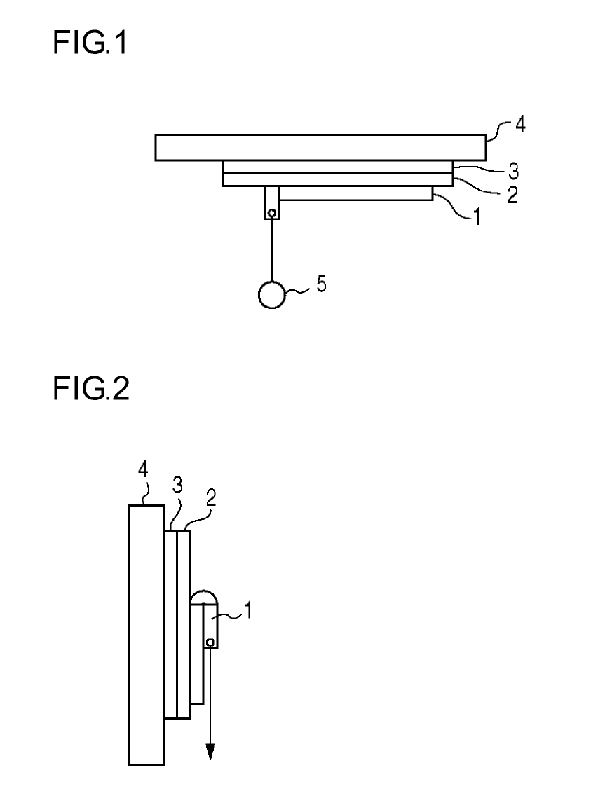

After the lamination, the sample was left uncontrolled under the environment of 23° C.×50% RH for 30 minutes, and then the opposite surface of the triacetyl cellulose polarizing plate 2 was fixed to an acrylic board 4 with a double-sided pressure-sensitive adhesive tape 3 and a constant load 5 (1.2 g) was fixed to one end portion of a pressure-sensitive adhesive sheet 1, as illustrated in FIG. 1. Peeling of the tape sample was initiated by the constant load such that a peel angle became 90°. Assuming that a 10-mm length of the tape sample was to remain, a period of time, until the remaining length of 50 mm was all peeled, was measured. The measurement was performed under the environment of 23° C.×50% RH. A sample, in which a peeling time was 100 seconds or longer under the constant load, was determined to be good, while a sample, in which it was shorter than 100 seconds, was determined to be no good. Results of the measurement are shown in Table 3.

### (High-Speed Peeling Test: 180° Peeling Pressure-Sensitive Adhesive Force)

An evaluation sample (optical film with surface protective sheet) was produced as follows: the pressure-sensitive adhesive sheet according to each of Examples and Comparative Examples was cut into a size of 25 mm in width×100 mm in length; and after the release liner was peeled, the sheet was pressure-attached to the surface of a triacetyl cellulose polarizing plate (product name: SEG1425DU made by NITTO DENKO CORPORATION, width: 70 mm, length: 100 mm) with a hand roller and then laminated in the pressure-bonding conditions of 0.25 MPa and 0.3 m/min.

After the lamination, the sample was left uncontrolled under the environment of 23° C.×50% RH for 30 minutes, and then the opposite surface of the triacetyl cellulose polarizing plate 2 was fixed to an acrylic board 4 with a double-sided pressure-sensitive adhesive tape 3, and one end portion of a pressure-sensitive adhesive sheet 1 was peeled by a universal tensile testing machine, as illustrated in FIG. 2. The pressure-sensitive adhesive force, occurring when peeled at a tensile speed of 30 m/min and at a peel angle of 180°, was measured. The measurement was performed under the environment of 23° C.×50% RH. A sample, in which the pressure-sensitive adhesive force at high-speed peeling was smaller than 1.5 N/25 mm, was determined to be good, while a sample, in which it was larger than or equal to 1.5 N/25 mm, was determined to be no good. Results of the measurement are shown in Table 3.

### (Transparency Test: Haze)

After the pressure-sensitive adhesive sheet according to each of Examples and Comparative Examples was cut into a size of 50 mm in width×50 mm in length, the release liner was peeled, so that the haze thereof was measured by a haze meter (made by MURAKAMI COLOR RESEARCH LABORATORY CO., Ltd.). A sample having a haze less than 7.3% was determined to be good, while a sample having a haze more than or equal to 7.3% was determined to be no good. Results of the measurement are shown in Table 3.

TABLE 3

| | CONSTANT | PRESSURE-SENSITIVE | |
|---|---|---|---|
| | LOAD | ADHESIVE FORCE AT | |
| | PEELING | HIGH-SPEED PEELING | HAZE |
| | TEST (SEC) | (N/25 mm) | (%) |
| EXAMPLE 1 | 687 | 0.87 | 2.0 |
| EXAMPLE 2 | 966 | 0.81 | 3.2 |
| EXAMPLE 3 | 435 | 0.87 | 2.8 |
| EXAMPLE 4 | 280 | 0.61 | 2.2 |
| EXAMPLE 5 | 237 | 0.26 | 3.2 |
| EXAMPLE 6 | 297 | 0.51 | 7.1 |
| EXAMPLE 7 | 406 | 0.22 | 3.5 |
| EXAMPLE 8 | 330 | 0.71 | 3.1 |
| EXAMPLE 9 | 244 | 0.35 | 2.5 |
| COMPARATIVE | 65 | 0.45 | 2.2 |
| EXAMPLE 1 | | | |
| COMPARATIVE | 1401 | 0.56 | 7.5 |
| EXAMPLE 2 | | | |
| COMPARATIVE | 291 | 1.85 | 3.2 |
| EXAMPLE 3 | | | |
| COMPARATIVE | 384 | 2.25 | 3.5 |
| EXAMPLE 4 | | | |

As shown in Table 3, it has been confirmed that, in Comparative Example 1 in which the (meth)acrylic polymer (B) having a weight average molecular weight (M_{WB}) of 1000≦M_{WB}<50000 and a glass transition temperature of 30 to 300° C. was not used, the pressure-sensitive adhesive force at low-speed peeling was not sufficient. It has been also confirmed that: in Comparative Example 2 in which the (meth)acrylic polymers (B) was added in an amount of 3 parts by mass or more, the transparency was not sufficient; in Comparative Example 3 in which polypropylene glycol was used, instead of the organopolysiloxane compound (C) having a polyoxyalkylene chain, the pressure-sensitive adhesive force at high-speed peeling was large; and in Comparative Example 4 in which polyethylene glycol-polypropylene glycol was used, instead of the organopolysiloxane compound (C) having a polyoxyalkylene chain, the pressure-sensitive adhesive force at high-speed peeling was large.

In each of Embodiments, the high-speed peelability and the low-speed peelability were both satisfied. The transparency was also good.

The aforementioned embodiments will be summarized as follows.

(Item 1) A pressure-sensitive adhesive composition comprising: 100 parts by mass of a polymer (A) having a glass transition temperature lower than 0° C.; 0.05 parts by mass to 3 parts by mass of a (meth)acrylic polymer (B) having a weight average molecular weight (M_{WB}) of 1000≦M_{WB}<50000 and a glass transition temperature of 30 to 300° C.; and an organopolysiloxane compound (C) having a polyoxyalkylene chain, represented by any one of the following general formulae (C1) to (C3).

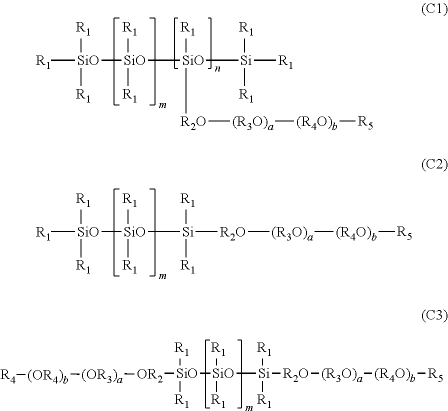

[In Formula (C1), R₁ is a monovalent organic group, each of R₂, R₃, and R₄ is an alkylene group, R₅ is a hydrogen or an organic group, each of m and n is an integer of 0 to 1000 (however, they are not 0 at a time), and each of a and b is an integer of 0 to 1000 (however, they are not 0 at a time)];

[In Formula (C2), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time)]; and

[In Formula (C3), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time).]

(Item 2) The pressure-sensitive adhesive composition according to Item 1 comprising the compound (C) in an amount of 0.01 to 2.5 parts by mass.

(Item 3) The pressure-sensitive adhesive composition according to Item 1 or Item 2, wherein the polymer (A) is an acrylic polymer.

(Item 4) The pressure-sensitive adhesive composition according to any one of Items 1 to 3, wherein the (meth)acrylic polymer (B) is a (meth)acrylic polymer including, as a monomer unit, a (meth)acrylic monomer having an alicyclic structure represented by the following general formula (1).

CH₂═C(R¹)COOR² (1)

[wherein R¹ is a hydrogen atom or a methyl group and R² is an alicyclic hydrocarbon group having an alicyclic structure.]

(Item 5) The pressure-sensitive adhesive composition according to Item 4, wherein an alicyclic hydrocarbon group in the (meth)acrylic monomer having an alicyclic structure has a bridged ring structure.

(Item 6) The pressure-sensitive adhesive composition according to any one of Items 3 to 5, wherein the acrylic polymer further includes, as a monomer component, a hydroxyl group-containing (meth)acrylic monomer.

(Item 7) A pressure-sensitive adhesive layer made of the pressure-sensitive adhesive composition according to any one of Items 1 to 6.

(Item 8) The pressure-sensitive adhesive layer according to Item 7 including 85.00 to 99.95% by mass of a solvent-insoluble component.

(Item 9) A pressure-sensitive adhesive sheet made by forming the pressure-sensitive adhesive layer according to Item 7 or Item 8 on at least one surface of a supporting body.

(Item 10) The pressure-sensitive adhesive sheet according to Item 9, wherein the supporting body is a plastic film, which is subjected to an antistatic treatment.

(Item 11) A surface protective sheet made of the pressure-sensitive adhesive sheet according to Item 9 or Item 10.

(Item 12) An optical surface protective sheet that is made of the surface protective sheet according to Item 11 and is used for protecting a surface of an optical film.

(Item 13) An optical film with surface protective sheet, wherein the optical surface protective sheet according to Item 12 is attached to the optical film.

What is claimed is:

1. A pressure-sensitive adhesive composition comprising:
100 parts by mass of a polymer (A) having a glass transition temperature lower than 0° C.;
0.05 parts by mass to 3 parts by mass of a (meth)acrylic polymer (B) having a weight average molecular weight (M_{WB}) of 1000≦M_{WB}<50000 and a glass transition temperature of 30 to 300° C.; and
an organopolysiloxane compound (C) having a polyoxyalkylene chain, represented by any one of the following general formulae (C1) to (C3). 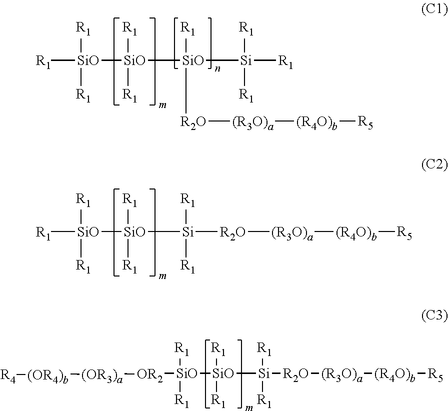
[In Formula (C1), R₁ is a monovalent organic group, each of R₂, R₃, and R₄ is an alkylene group, R₅ is a hydrogen or an organic group, each of m and n is an integer of 0 to 1000 (however, they are not 0 at a time), and each of a and b is an integer of 0 to 1000 (however, they are not 0 at a time)];
[In Formula (C2), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time)]; and
[In Formula (C3), R₁ is a monovalent organic group, each of R₂, R₃, and R₄ is an alkylene group, R₅ is a hydrogen or an organic group, m is an integer of 1 to 2000, and each of a and b is an integer of 0 to 1000 (however, they are not 0 at a time).]

2. The pressure-sensitive adhesive composition according to claim 1 comprising the compound (C) in an amount of 0.01 to 2.5 parts by mass.

3. The pressure-sensitive adhesive composition according to claim 1, wherein
the polymer (A) is an acrylic polymer.

4. The pressure-sensitive adhesive composition according to claim 1, wherein
the (meth)acrylic polymer (B) is a (meth)acrylic polymer including, as a monomer unit, a (meth)acrylic monomer having an alicyclic structure represented by the following general formula (1).
CH₂═C(R¹)COOR² (1)
[wherein R¹ is a hydrogen atom or a methyl group and R² is an alicyclic hydrocarbon group having an alicyclic structure.]

5. The pressure-sensitive adhesive composition according to claim 4, wherein
an alicyclic hydrocarbon group in the (meth)acrylic monomer having an alicyclic structure has a bridged ring structure.

6. The pressure-sensitive adhesive composition according to claim 3, wherein
the acrylic polymer further includes, as a monomer component, a hydroxyl group-containing (meth)acrylic monomer.

7. A pressure-sensitive adhesive layer made of the pressure-sensitive adhesive composition according to claim 1.

8. The pressure-sensitive adhesive layer according to claim 7 including 85.00 to 99.95% by mass of a solvent-insoluble component.

9. A pressure-sensitive adhesive sheet made by forming the pressure-sensitive adhesive layer according to claim 7 on at least one surface of a supporting body.

10. The pressure-sensitive adhesive sheet according to claim 9, wherein
the supporting body is a plastic film, which is subjected to an antistatic treatment.

11. A surface protective sheet made of the pressure-sensitive adhesive sheet according to claim 9.

12. An optical surface protective sheet that is made of the surface protective sheet according to claim 11 and is used for protecting a surface of an optical film.

13. An optical film with surface protective sheet, wherein the optical surface protective sheet according to claim 12 is attached to the optical film.

14. The pressure-sensitive adhesive composition according to claim 2, wherein
the polymer (A) is an acrylic polymer.

15. The pressure-sensitive adhesive composition according to claim 2, wherein
the (meth)acrylic polymer (B) is a (meth)acrylic polymer including, as a monomer unit, a (meth)acrylic monomer having an alicyclic structure represented by the following general formula (1).
CH₂═C(R¹)COOR² (1)
[wherein R¹ is a hydrogen atom or a methyl group and R² is an alicyclic hydrocarbon group having an alicyclic structure.]

16. The pressure-sensitive adhesive composition according to claim 3, wherein
the (meth)acrylic polymer (B) is a (meth)acrylic polymer including, as a monomer unit, a (meth)acrylic monomer having an alicyclic structure represented by the following general formula (1).
CH₂═C(R¹)COOR² (1)
[wherein R¹ is a hydrogen atom or a methyl group and R² is an alicyclic hydrocarbon group having an alicyclic structure.]

17. The pressure-sensitive adhesive composition according to claim 14, wherein
the (meth)acrylic polymer (B) is a (meth)acrylic polymer including, as a monomer unit, a (meth)acrylic monomer having an alicyclic structure represented by the following general formula (1).
CH₂═C(R¹)COOR² (1)
[wherein R¹ is a hydrogen atom or a methyl group and R² is an alicyclic hydrocarbon group having an alicyclic structure.]

18. The pressure-sensitive adhesive composition according to claim 15, wherein
an alicyclic hydrocarbon group in the (meth)acrylic monomer having an alicyclic structure has a bridged ring structure.

19. The pressure-sensitive adhesive composition according to claim 16, wherein
an alicyclic hydrocarbon group in the (meth)acrylic monomer having an alicyclic structure has a bridged ring structure.

20. The pressure-sensitive adhesive composition according to claim 17, wherein
an alicyclic hydrocarbon group in the (meth)acrylic monomer having an alicyclic structure has a bridged ring structure.
